(19) United States
(12) Patent Application Publication
(10) Pub. No.: US 2014/0126914 A1
(43) Pub. Date: May 8, 2014

(54) OPTICAL FIBER-BASED DISTRIBUTED RADIO FREQUENCY (RF) ANTENNA SYSTEMS SUPPORTING MULTIPLE-INPUT, MULTIPLE-OUTPUT (MIMO) CONFIGURATIONS, AND RELATED COMPONENTS AND METHODS

(71) Applicant: Corning Cable Systems LLC, Hickory, NC (US)

(72) Inventors: Igor Berlin, Potomac, MD (US); William Patrick Cune, Charlotte, NC (US); Jessica Joy Kedziora, Mannsville, NY (US); Michael Sauer, Corning, NY (US); Gerald Bernhart Schmidt, Painted Post, NY (US); Wolfgang Gottfried Tobias Schweiker, Weyan (DE)

(73) Assignee: Corning Cable Systems LLC, Hickory, NC (US)

(21) Appl. No.: 14/148,908

(22) Filed: Jan. 7, 2014

Related U.S. Application Data
(63) Continuation of application No. PCT/US2011/043405, filed on Jul. 8, 2011.
(60) Provisional application No. 61/363,007, filed on Jul. 9, 2010.

(51) Int. Cl. H04B 10/2575; H04B 7/04

(52) U.S. Cl. CPC H04B 10/25753; H04B 7/0413
USPC 398/116

(57) ABSTRACT

Optical fiber-based distributed antenna systems that support multiple-input, multiple-output (MIMO) antenna configurations and communications. Embodiments disclosed herein include optical fiber-based distributed antenna system that can be flexibly configured to support or not support MIMO communications configurations. In one embodiment, first and second MIMO communication paths are shared on the same optical fiber using frequency conversion to avoid interference issues, wherein the second communication path is provide to a remote extension unit to remote antenna unit. In another embodiment, the optical fiber-based distributed antenna systems may be configured to allow to provide MIMO communication configurations with existing components. Existing capacity of system components are employed to create second communication paths for MIMO configurations, thereby reducing overall capacity, but allowing avoidance of frequency conversion components and remote extension units.

### PRIORITY APPLICATION

This application is a continuation of PCT Application No. PCT/US2011/43405, filed Jul. 8, 2011, which claims the benefit of priority under 35 U.S.C. §119 of U.S. Provisional Application No. 61/363,007 filed on Jul. 9, 2010, entitled “Optical Fiber-based Distributed Radio Frequency (RF) Communications Systems, and Related Components and Methods,” the content of which is relied upon and incorporated herein by reference in its entirety.

### RELATED APPLICATIONS

The present application is related to International Application No. PCT/US11/34733 filed on May 2, 2011, entitled “Optical Fiber-based Distributed Communications Systems, and Related Components and Methods,” which is incorporated herein by reference in its entirety, and which claims priority to U.S. Provisional Patent Application Ser. No. 61/330,383 filed on May 2, 2010, entitled “Optical Fiber-based Distributed Communications Systems, and Related Components and Methods.”

The present application is also related U.S. patent application Ser. No. 12/914,585 filed on Oct. 28, 2010, entitled “Sectorization In Distributed Antenna Systems, and Related Components and Method,” which is incorporated herein by reference in its entirety.

### BACKGROUND

1. Field of the Disclosure

The technology of the disclosure relates to optical fiber-based distributed communications systems for distributing radio frequency (RF) signals over optical fiber.

2. Technical Background

Wireless communication is rapidly growing, with ever-increasing demands for high-speed mobile data communication. As an example, so-called “wireless fidelity” or “WiFi” systems and wireless local area networks (WLANs) are being deployed in many different types of areas (e.g., coffee shops, airports, libraries, etc.). Distributed communications or antenna systems communicate with wireless devices called “clients,” which must reside within the wireless range or “cell coverage area” in order to communicate with an access point device.

One approach to deploying a distributed antenna system involves the use of radio frequency (RF) antenna coverage areas, also referred to as “antenna coverage areas.” Antenna coverage areas can have a radius in the range from a few meters up to twenty meters as an example. Combining a number of access point devices creates an array of antenna coverage areas. Because the antenna coverage areas each cover small areas, there are typically only a few users (clients) per antenna coverage area. This allows for minimizing the amount of RF bandwidth shared among the wireless system users. It may be desirable to provide antenna coverage areas in a building or other facility to provide distributed antenna system access to clients within the building or facility. However, it may be desirable to employ optical fiber to distribute communications signals. Benefits of optical fiber include increased bandwidth.

One type of distributed antenna system for creating antenna coverage areas, called “Radio-over-Fiber” or “RoF,” utilizes RF signals sent over optical fibers. Such systems can include head-end equipment optically coupled to a plurality of remote antenna units that each provides antenna coverage areas. The remote antenna units can each include RF transceivers coupled to an antenna to transmit RF signals wirelessly, wherein the remote antenna units are coupled to the head-end equipment via optical fiber links. The RF transceivers in the remote antenna units are transparent to the RF signals. The remote antenna units convert incoming optical RF signals from an optical fiber downlink to electrical RF signals via optical-to-electrical (O/E) converters, which are then passed to the RF transceiver. The RF transceiver converts the electrical RF signals to electromagnetic signals via antennas coupled to the RF transceiver provided in the remote antenna units. The antennas also receive electromagnetic signals (i.e., electromagnetic radiation) from clients in the antenna coverage area and convert them to electrical RF signals (i.e., electrical RF signals in wire). The remote antenna units then convert the electrical RF signals to optical RF signals via electrical-to-optical (E/O) converters. The optical RF signals are then sent over an optical fiber uplink to the head-end equipment.

Optical-fiber based distributed antenna systems may have limitations on performance (i.e., data rate) based on the particular components and configurations chosen for the system. It may be desired to be able to improve communications performance of optical fiber-based distributed antenna systems as the needs for the system increase over time. The data rate needs for the system may increase after initial installation as an example. It may be desirable to be able to increase the data rate of an optical fiber-based distributed antenna system without requiring additional bandwidth or transmit power.

### SUMMARY OF THE DETAILED DESCRIPTION

Embodiments disclosed in the detailed description include optical fiber-based distributed antenna systems that support multiple-input, multiple-output (MIMO) antenna configurations and communications. MIMO communications configurations involve the use of multiple antennas at both the transmitter and a receiver to improve communications performance. MIMO can offer significant increases in data communications rates without requiring additional bandwidth or transmit power by higher spectral efficiency (i.e., more data per second per hertz of bandwidth) ad link reliability or diversity to reduce fading. Embodiments disclosed herein also include optical fiber-based distributed antenna system that can be flexibly configured to support or not support MIMO communications configurations. When configured to support MIMO communications configurations, the optical fiber-based distributed antenna systems can be provided that allow for MIMO configurations without consuming additional capacity of the system and/or using existing components in the system.

In certain embodiments, first and second MIMO communications signals are shared on the same optical fiber communication path to avoid consuming other resources in the system and as a result potentially reducing capacity. In this regard, frequency conversion is used to avoid the communications signals for the MIMO interfering with each other on the common optical fiber. The second communications signals are frequency converted to a different frequency from the radio band configured for MIMO and are provided to a remote extension unit to remote antenna unit via an interface to a remote antenna unit (RAU). The remote extension unit converts the frequency of the signals from the second communication path back to the radio band configured for MIMO. For uplink communications, radio interfaces providing the second communications signals are also configured to convert the frequency to the radio band configured for MIMO.

In other embodiments, existing capacity of system components are employed to create second communication paths for MIMO configurations. Communications signals for MIMO do not share communications paths, and thereby frequency conversion is not required to prevent interference of the communications signals. However, providing separate communication paths for MIMO communications consumes additional system resources that may reduce the overall capacity of the system.

In this regard in these embodiments, an apparatus configured to distribute radio-frequency (RF) communications signals in a distributed antenna system in a multiple-input, multiple-output (MIMO) configuration is provided. The apparatus comprises at least one first radio interface configured to distribute received first downlink electrical RF communications signals in a first radio band frequency into first downlink electrical RF communications signals. The apparatus also comprises at least one second radio interface configured to distribute received second downlink electrical RF communications signals in the first radio band frequency into second downlink electrical RF communications signals. The apparatus also comprises at least one first optical interface configured to receive the first downlink electrical RF communications signals from the at least one first radio interface, convert the received first downlink electrical RF communications signals from the at least one first radio interface into first downlink optical RF communications signals, and distribute the first downlink optical RF communications signals over optical fiber in a first downlink communication path to at least one remote antenna unit (RAU). The apparatus also comprises at least one second optical interface configured to receive the second downlink electrical RF communications signals from the at least one second radio interface, convert the received second downlink electrical RF communications signals from the at least one second radio interface into second downlink optical RF communications signals, distribute the second downlink optical RF communications signals over optical fiber in a second downlink communication path to at least one second remote unit.

In others embodiments, a method of distributing radio-frequency (RF) communications signals in a distributed antenna system in a multiple-input, multiple-output (MIMO) configuration is provided. The method comprises distributing received first downlink electrical RF communications signals in a first radio band frequency into first downlink electrical RF communications signals from at least one first radio interface. The method also comprises distributing received second downlink electrical RF communications signals in the first radio band frequency into second downlink electrical RF communications signals from at least one second radio interface. The method also comprises in at least one first optical interface: receiving the first downlink electrical RF communications signals from the at least one first radio interface, converting the received first downlink electrical RF communications signals from the at least one first radio interface into first downlink optical RF communications signals, and distributing the first downlink optical RF communications signals over optical fiber in a first downlink communication path to at least one remote antenna unit (RAU). The method also comprises in at least one second optical interface: receiving the second downlink electrical RF communications signals from the at least one second radio interface, converting the received second downlink electrical RF communications signals from the at least one second radio interface into second downlink optical RF communications signals, distributing the second downlink optical RF communications signals over optical fiber in a second downlink communication path to at least one second remote unit.

As a non-limiting example, the distributed antenna system may be an optical fiber-based distributed antenna system, but such is not required. The embodiments disclosed herein are also applicable to other distributed antenna systems, including those that include other forms of communications media for distribution of communications signals, including electrical conductors and wireless transmission. The embodiments disclosed herein may also be applicable to distributed antenna system may also include more than one communications media for distribution of communications signals.

Embodiments disclosed in the detailed description include optical fiber-based distributed antenna systems that provide and support both radio frequency (RF) communication services and digital data services. The RF communication services and digital data services can be distributed over optical fiber to client devices, such as remote antenna units for example. For example, non-limiting examples of digital data services include WLAN, WiMax, WiFi, Digital Subscriber Line (DSL), and LTE, etc. Digital data services can be distributed over optical fiber separate from optical fiber distributing RF communication services. Alternatively, digital data services can be distributed over common optical fiber with RF communication services. For example, digital data services can be distributed over common optical fiber with RF communication services at different wavelengths through wavelength-division multiplexing (WDM) and/or at different frequencies through frequency-division multiplexing (FDM). Power distributed in the optical fiber-based distributed antenna system to provide power to remote antenna units can also be accessed to provide power to digital data service components.

Additional features and advantages will be set forth in the detailed description which follows, and in part will be readily apparent to those skilled in the art from that description or recognized by practicing the embodiments as described herein.

It is to be understood that both the foregoing general description and the following detailed description present embodiments, and are intended to provide an overview or framework for understanding the nature and character of the disclosure. The accompanying drawings illustrate various embodiments, and together with the description serve to explain the principles and operation of the concepts disclosed.

### BRIEF DESCRIPTION OF THE FIGURES

FIG. 1 is a schematic diagram of an exemplary optical fiber-based distributed antenna system;

FIG. 2 is a more detailed schematic diagram of exemplary head-end equipment and a remote antenna unit (RAU) that can be deployed in the optical fiber-based distributed antenna system of FIG. 1;

FIG. 3A is a partially schematic cut-away diagram of an exemplary building infrastructure in which the optical fiber-based distributed antenna system in FIG. 1 can be employed;

FIG. 3B is an alternative diagram of the optical fiber-based distributed antenna system in FIGS. 1 and 3A;

FIG. 4 is a schematic diagram of exemplary head-end equipment (HEE) to provide radio frequency (RF) communication services over optical fiber to RAUs or other remote communications devices in an optical fiber-based distributed antenna system;

FIG. 5 is a schematic diagram of an exemplary optical fiber-based distributed antenna system with alternative equipment to provide RF communication services over optical fiber and digital data services as electrical signals to RAUs or other remote communications devices in an optical fiber-based distributed antenna system;

FIG. 6 is a schematic diagram of providing digital data services as electrical signals and RF communication services over optical fiber to RAUs or other remote communications devices in the optical fiber-based distributed antenna system of FIG. 5;

FIG. 7 is a schematic diagram illustrating a single band MIMO configuration upgrade in the exemplary optical fiber-based distributed antenna system in FIG. 5;

FIG. 8 is a schematic diagram of a first radio interface employed in the HEE for a first communication path in the MIMO configuration in the distributed optical fiber-based distributed antenna system in FIG. 7;

FIG. 9 is a schematic diagram of a second radio interface employed in the HEE for a second communication path in the MIMO configuration in the distributed optical fiber-based distributed antenna system in FIG. 7;

FIG. 10 is a schematic diagram of a RAU configured to distribute RF communications signals for the first communication path in the MIMO configuration in the distributed optical fiber-based distributed antenna system in FIG. 7;

FIG. 11 is a schematic diagram of the remote expansion unit (RXU) coupled to the RAU in FIG. 10 and configured to distribute RF communications signals for the second communication path in the MIMO configuration in the distributed optical fiber-based distributed antenna system in FIG. 7;

FIG. 12 is a schematic diagram illustrating an alternative single band MIMO upgrade in the system architecture of an optical fiber-based distributed antenna system of FIG. 5;

FIG. 13 is a schematic diagram illustrating a multi-band MIMO upgrade in the system architecture of an optical fiber-based distributed antenna system;

FIG. 14 is a schematic diagram illustrating providing Ethernet data service in an optical fiber-based distributed antenna system;

FIG. 15 is a schematic diagram of an exemplary RAU that can be employed in an optical fiber-based distributed antenna system and having a Remote Expansion Unit (RXU);

FIG. 16 is an example of a main status user interface screen for an optical fiber-based distributed antenna system; and

FIG. 17 is a schematic diagram of a generalized representation of an exemplary computer system that can be included in any of the modules provided in the exemplary distributed antenna systems and/or their components described herein, including but not limited to a head end controller (HEC), wherein the exemplary computer system is adapted to execute instructions from an exemplary computer-readable media.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include optical fiber-based distributed antenna systems that support multiple-input, multiple-output (MIMO) antenna configurations and communications. MIMO communications configurations involve the use of multiple antennas at both the transmitter and a receiver to improve communications performance. MIMO can offer significant increases in data communications rates without requiring additional bandwidth or transmit power by higher spectral efficiency (i.e., more data per second per hertz of bandwidth) ad link reliability or diversity to reduce fading. Embodiments disclosed herein also include optical fiber-based distributed antenna system that can be flexibly configured to support or not support MIMO communications configurations. When configured to support MIMO communications configurations, the optical fiber-based distributed antenna systems can be provided that allow for MIMO configurations without consuming additional capacity of the system and/or using existing components in the system.

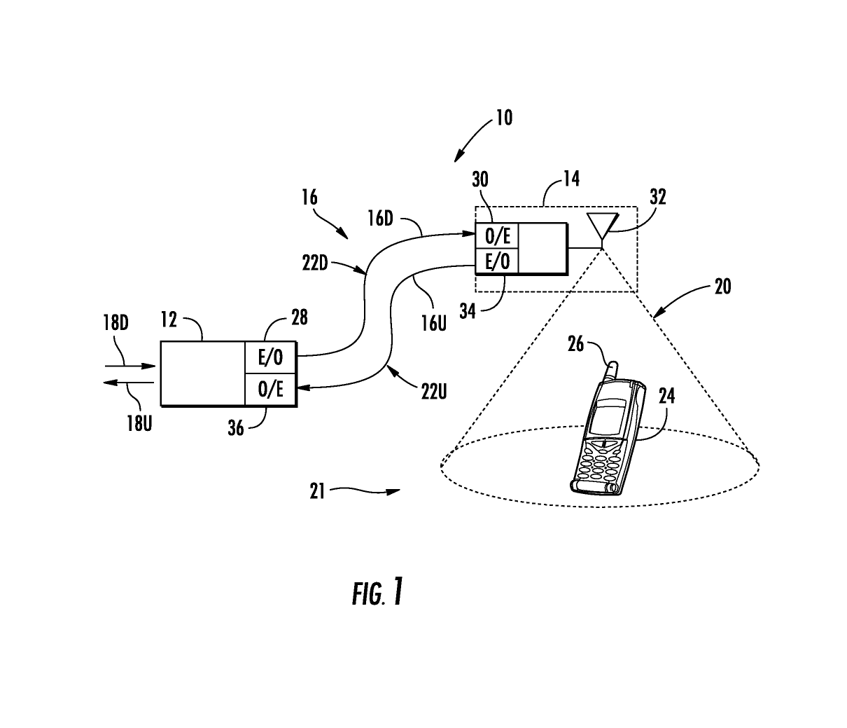

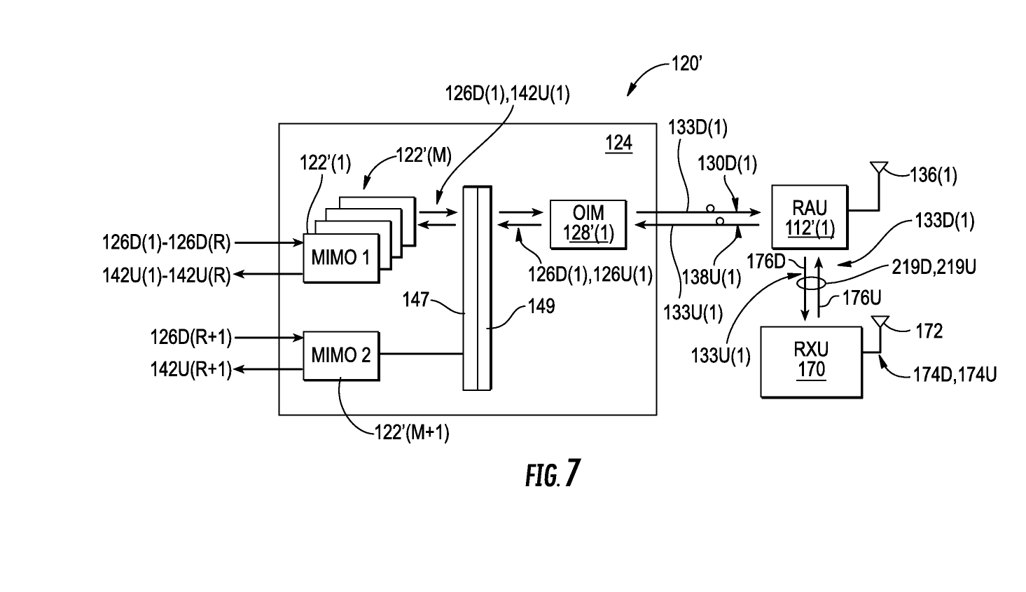

Before discussing examples of optical fiber-based distributed antenna systems supporting MIMO configurations and their related components and methods, an exemplary distributed antenna systems capable of distributing RF communications signals to distributed or remote antenna units is first described with regard to FIGS. 1-6. Embodiments of providing MIMO configurations in optical fiber-based distributed antenna systems starts at FIG. 7. The optical fiber-based distributed antenna systems in FIGS. 1-6 discussed below include distribution of radio frequency (RF) communications signals; however, the distributed antenna systems are not limited to distribution of RF communications signals. Also note that while the optical fiber-based distributed antenna systems in FIGS. 1-6 discussed below include distribution of communications signals over optical fiber, these distributed antenna systems are not limited to distribution over optical fiber. Distribution mediums could also, but not limited to, include coaxial cable, twisted-pair conductors, wireless transmission and reception, and any combination thereof. Also, any combination can be employed that also involve optical fiber for portions of the distributed antenna system.

In this regard, FIG. 1 is a schematic diagram of an embodiment of a distributed antenna system. In this embodiment, the system is an optical fiber-based distributed antenna system 10. The optical fiber-based distributed antenna system 10 is configured to create one or more antenna coverage areas for establishing communications with wireless client devices located in the RF range of the antenna coverage areas. The optical fiber-based distributed antenna system 10 provides RF communication services (e.g., cellular services). In this embodiment, the optical fiber-based distributed antenna system 10 includes head-end equipment (HEE) 12 such as a head-end unit (HEU), one or more remote antenna units (RAUs) 14, and an optical fiber 16 that optically couples the HEE 12 to the RAU 14. The RAU 14 is a type of remote communications unit. In general, a remote communications unit can support either wireless communications, wired communications, or both. The RAU 14 can support wireless communications and may also support wired communications. The HEE 12 is configured to receive communications over downlink electrical RF signals 18D from a source or sources, such as a network or carrier as examples, and provide such communications to the RAU 14. The HEE 12 is also configured to return communications received from the RAU 14, via uplink electrical RF signals 18U, back to the source or sources. In this regard in this embodiment, the optical fiber 16 includes at least one downlink optical fiber 16D to carry signals communicated from the HEE 12 to the RAU 14 and at least one uplink optical fiber 16U to carry signals communicated from the RAU 14 back to the HEE 12.

One downlink optical fiber 16D and one uplink optical fiber 16U could be provided to support multiple channels each using wave-division multiplexing (WDM), as discussed in U.S. patent application Ser. No. 12/892,424 entitled “Providing Digital Data Services in Optical Fiber-based Distributed Radio Frequency (RF) Communications Systems, And Related Components and Methods,” incorporated herein by reference in its entirety. Other options for WDM and frequency-division multiplexing (FDM) are disclosed in U.S. patent application Ser. No. 12/892,424, any of which can be employed in any of the embodiments disclosed herein. Further, U.S. patent application Ser. No. 12/892,424 also discloses distributed digital data communications signals in a distributed antenna system which may also be distributed in the optical fiber-based distributed antenna system 10 either in conjunction with RF communications signals or not.

The optical fiber-based distributed antenna system 10 has an antenna coverage area 20 that can be disposed about the RAU 14. The antenna coverage area 20 of the RAU 14 forms an RF coverage area 21. The HEE 12 is adapted to perform or to facilitate any one of a number of Radio-over-Fiber (RoF) applications, such as RF identification (RFID), wireless local-area network (WLAN) communication, or cellular phone service. Shown within the antenna coverage area 20 is a client device 24 in the form of a mobile device as an example, which may be a cellular telephone as an example. The client device 24 can be any device that is capable of receiving RF communications signals. The client device 24 includes an antenna 26 (e.g., a wireless card) adapted to receive and/or send electromagnetic RF signals.

With continuing reference to FIG. 1, to communicate the electrical RF signals over the downlink optical fiber 16D to the RAU 14, to in turn be communicated to the client device 24 in the antenna coverage area 20 formed by the RAU 14, the HEE 12 includes a radio interface in the form of an electrical-to-optical (E/O) converter 28. The E/O converter 28 converts the downlink electrical RF signals 18D to downlink optical RF signals 22D to be communicated over the downlink optical fiber 16D. The RAU 14 includes an optical-to-electrical (O/E) converter 30 to convert received downlink optical RF signals 22D back to electrical RF signals to be communicated wirelessly through an antenna 136 of the RAU 14 to client devices 24 located in the antenna coverage area 20.

Similarly, the antenna 136 is also configured to receive wireless RF communications from client devices 24 in the antenna coverage area 20. In this regard, the antenna 136 receives wireless RF communications from client devices 24 and communicates electrical RF signals representing the wireless RF communications to an E/O converter 34 in the RAU 14. The E/O converter 34 converts the electrical RF signals into uplink optical RF signals 22U to be communicated over the uplink optical fiber 16U. An O/E converter 36 provided in the HEE 12 converts the uplink optical RF signals 22U into uplink electrical RF signals, which can then be communicated as uplink electrical RF signals 18U back to a network or other source. The HEE 12 in this embodiment is not able to distinguish the location of the client devices 24 in this embodiment. The client device 24 could be in the range of any antenna coverage area 20 formed by an RAU 14.

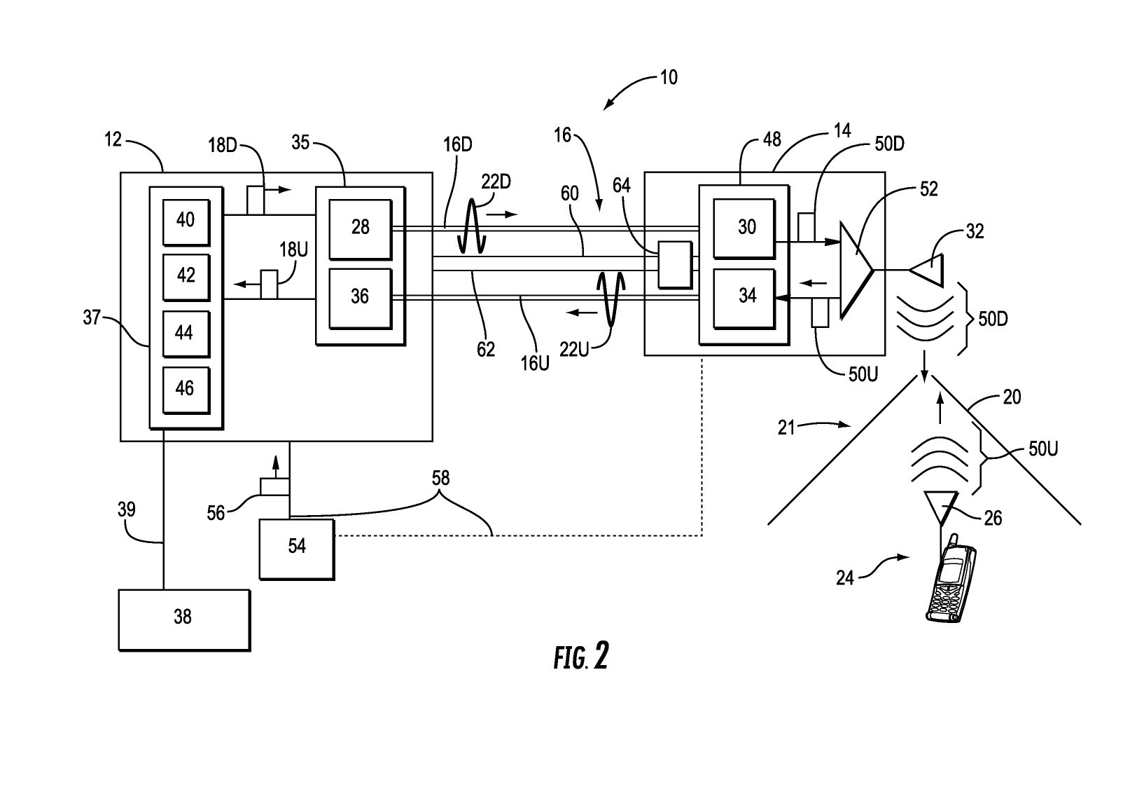

FIG. 2 is a more detailed schematic diagram of the exemplary optical fiber-based distributed antenna system 10 of FIG. 1 that provides electrical RF service signals for a particular RF service or application. In an exemplary embodiment, the HEE 12 includes a service unit 37 that provides electrical RF service signals by passing (or conditioning and then passing) such signals from one or more outside networks 38 via a network link 39. In a particular example embodiment, this includes providing cellular signal distribution in the frequency range from 400 MegaHertz (MHz) to 2.7 GigaHertz (GHz). Any other electrical RF signal frequencies are possible. In another exemplary embodiment, the service unit 37 provides electrical RF service signals by generating the signals directly. In another exemplary embodiment, the service unit 37 coordinates the delivery of the electrical RF service signals between client devices 24 within the antenna coverage area 20.

With continuing reference to FIG. 2, the service unit 37 is electrically coupled to the E/O converter 28 that receives the downlink electrical RF signals 18D from the service unit 37 and converts them to corresponding downlink optical RF signals 22D. In an exemplary embodiment, the E/O converter 28 includes a laser suitable for delivering sufficient dynamic range for the RoF applications described herein, and optionally includes a laser driver/amplifier electrically coupled to the laser. Examples of suitable lasers for the E/O converter 28 include, but are not limited to, laser diodes, distributed feedback (DFB) lasers, Fabry-Perot (FP) lasers, and vertical cavity surface emitting lasers (VCSELs).

With continuing reference to FIG. 2, the HEE 12 also includes the O/E converter 36, which is electrically coupled to the service unit 37. The O/E converter 36 receives the uplink optical RF signals 22U and converts them to corresponding uplink electrical RF signals 18U. In an example embodiment, the O/E converter 36 is a photodetector, or a photodetector electrically coupled to a linear amplifier. The E/O converter 28 and the O/E converter 36 constitute a “converter pair” 35, as illustrated in FIG. 2.

In accordance with an exemplary embodiment, the service unit 37 in the HEE 12 can include an RF signal conditioner unit 40 for conditioning the downlink electrical RF signals 18D and the uplink electrical RF signals 18U, respectively. The service unit 37 can include a digital signal processing unit (“digital signal processor”) 42 for providing to the RF signal conditioner unit 40 an electrical signal that is modulated onto an RF carrier to generate a desired downlink electrical RF signal 18D. The digital signal processor 42 is also configured to process a demodulation signal provided by the demodulation of the uplink electrical RF signal 18U by the RF signal conditioner unit 40. The HEE 12 can also include an optional central processing unit (CPU) 44 for processing data and otherwise performing logic and computing operations, and a memory unit 46 for storing data, such as data to be transmitted over a WLAN or other network for example.

With continuing reference to FIG. 2, the RAU 14 also includes a converter pair 48 comprising the O/E converter 30 and the E/O converter 34. The O/E converter 30 converts the received downlink optical RF signals 22D from the HEE 12 back into downlink electrical RF signals 50D. The E/O converter 34 converts uplink electrical RF signals 50U received from the client device 24 into the uplink optical RF signals 22U to be communicated to the HEE 12. The O/E converter 30 and the E/O converter 34 are electrically coupled to the antenna 136 via an RF signal-directing element 52, such as a circulator for example. The RF signal-directing element 52 serves to direct the downlink electrical RF signals 50D and the uplink electrical RF signals 50U, as discussed below. In accordance with an exemplary embodiment, the antenna 136 can include any type of antenna, including but not limited to one or more patch antennas, such as disclosed in U.S. patent application Ser. No. 11/504,999, filed Aug. 16, 2006 entitled “Radio-over-Fiber Transponder With A Dual-Band Patch Antenna System,” and U.S. patent application Ser. No. 11/451,553, filed Jun. 12, 2006 entitled “Centralized Optical Fiber-Based Wireless Picocellular Systems and Methods,” both of which are incorporated herein by reference in their entireties.

With continuing reference to FIG. 2, the optical fiber-based distributed antenna system 10 also includes a power supply 54 that provides an electrical power signal 56. The power supply 54 is electrically coupled to the HEE 12 for powering the power-consuming elements therein. In an exemplary embodiment, an electrical power line 58 runs through the HEE 12 and over to the RAU 14 to power the O/E converter 30 and the E/O converter 34 in the converter pair 48, the optional RF signal-directing element 52 (unless the RF signal-directing element 52 is a passive device such as a circulator for example), and any other power-consuming elements provided. In an exemplary embodiment, the electrical power line 58 includes two wires 60 and 62 that carry a single voltage and are electrically coupled to a DC power converter 64 at the RAU 14. The DC power converter 64 is electrically coupled to the O/E converter 30 and the E/O converter 34 in the converter pair 48, and changes the voltage or levels of the electrical power signal 56 to the power level(s) required by the power-consuming components in the RAU 14. In an exemplary embodiment, the DC power converter 64 is either a DC/DC power converter or an AC/DC power converter, depending on the type of electrical power signal 56 carried by the electrical power line 58. In another example embodiment, the electrical power line 58 (dashed line) runs directly from the power supply 54 to the RAU 14 rather than from or through the HEE 12. In another example embodiment, the electrical power line 58 includes more than two wires and may carry multiple voltages.

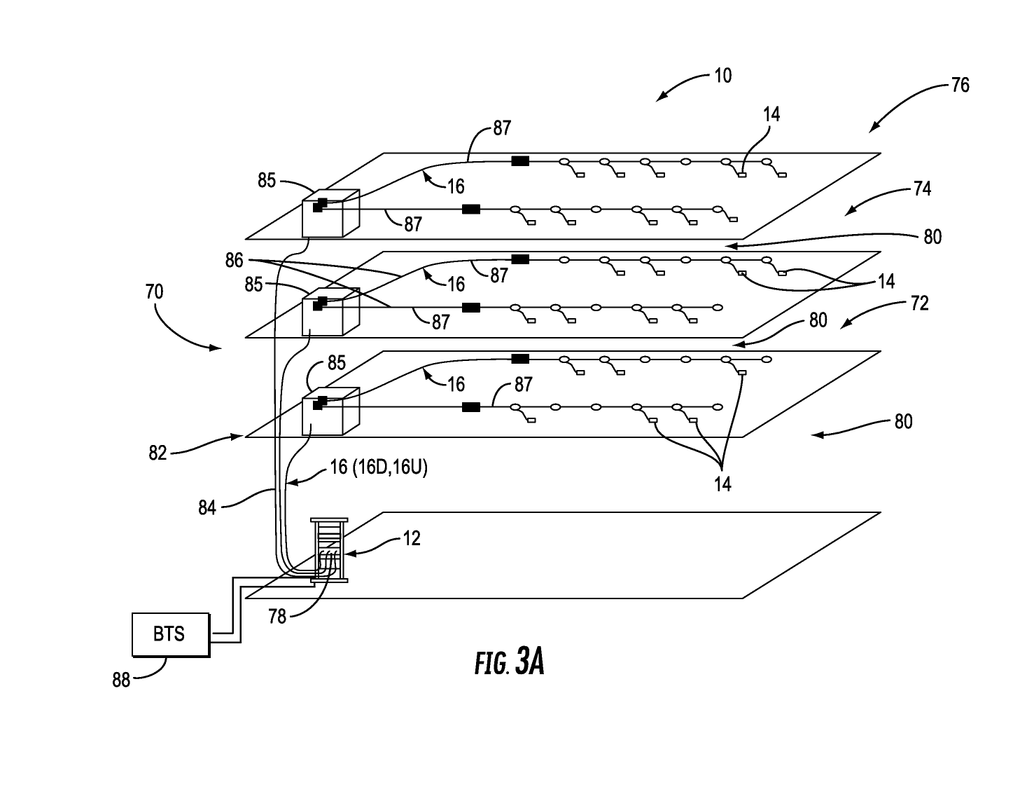

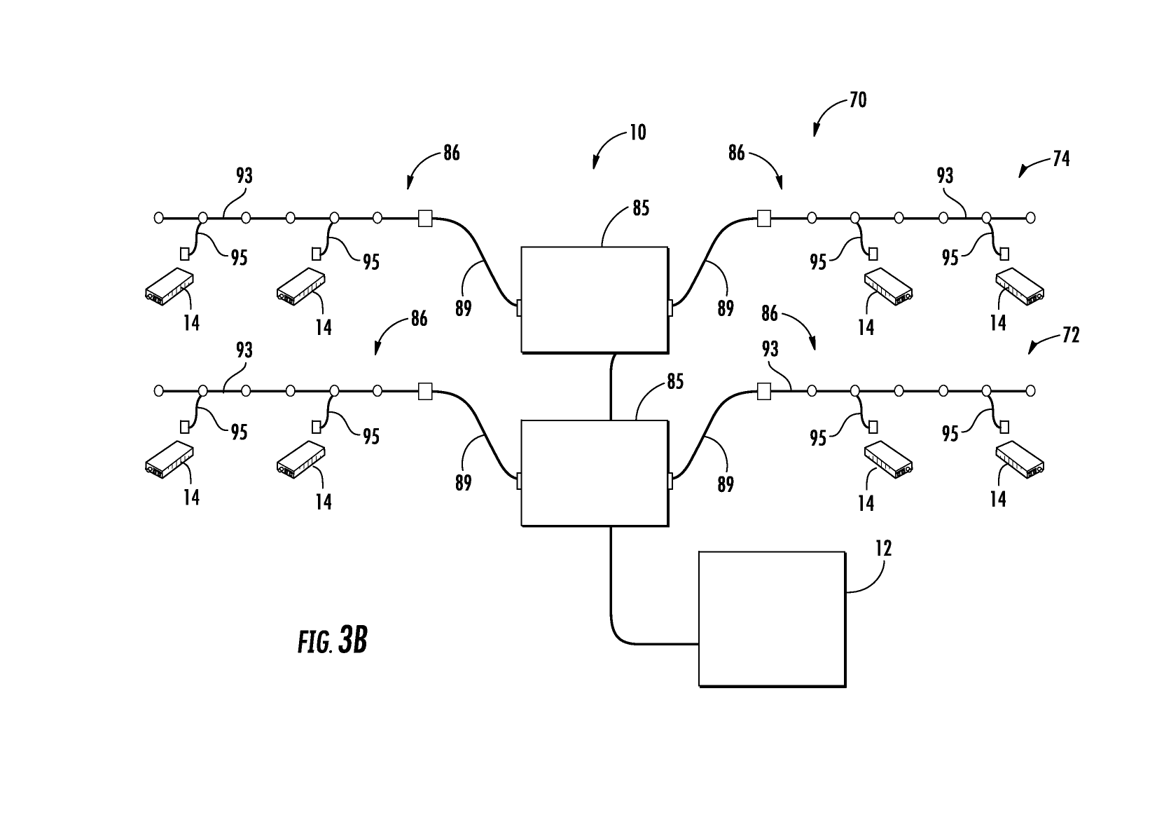

To provide further exemplary illustration of how an optical fiber-based distributed antenna system can be deployed indoors, FIG. 3A is provided. FIG. 3A is a partially schematic cut-away diagram of a building infrastructure 70 employing an optical fiber-based distributed antenna system. The system may be the optical fiber-based distributed antenna system 10 of FIGS. 1 and 2. The building infrastructure 70 generally represents any type of building in which the optical fiber-based distributed antenna system 10 can be deployed. As previously discussed with regard to FIGS. 1 and 2, the optical fiber-based distributed antenna system 10 incorporates the HEE 12 to provide various types of communication services to coverage areas within the building infrastructure 70, as an example.

For example, as discussed in more detail below, the optical fiber-based distributed antenna system 10 in this embodiment is configured to receive wireless RF signals and convert the RF signals into RoF signals to be communicated over the optical fiber 16 to multiple RAUs 14. The optical fiber-based distributed antenna system 10 in this embodiment can be, for example, an indoor distributed antenna system (IDAS) to provide wireless service inside the building infrastructure 70. These wireless signals can include cellular service, wireless services such as RFID tracking, Wireless Fidelity (WiFi), local area network (LAN), WLAN, public safety, wireless building automations, and combinations thereof, as examples.

With continuing reference to FIG. 3A, the building infrastructure 70 in this embodiment includes a first (ground) floor 72, a second floor 74, and a third floor 76. The floors 72, 74, 76 are serviced by the HEE 12 through a main distribution frame 78 to provide antenna coverage areas 80 in the building infrastructure 70. Only the ceilings of the floors 72, 74, 76 are shown in FIG. 3A for simplicity of illustration. In the example embodiment, a main cable 82 has a number of different sections that facilitate the placement of a large number of RAUs 14 in the building infrastructure 70. Each RAU 14 in turn services its own coverage area in the antenna coverage areas 80. The main cable 82 can include, for example, a riser cable 84 that carries all of the downlink and uplink optical fibers 16D, 16U to and from the HEE 12. The riser cable 84 may be routed through an interconnect unit (ICU) 85. The ICU 85 may be provided as part of or separate from the power supply 54 in FIG. 2. The ICU 85 may also be configured to provide power to the RAUs 14 via the electrical power line 58, as illustrated in FIG. 2 and discussed above, provided inside an array cable 87, or tail cable or home-run tether cable as other examples, and distributed with the downlink and uplink optical fibers 16D, 16U to the RAUs 14. For example, as illustrated in the building infrastructure 70 in FIG. 3B, a tail cable 89 may extend from the ICUs 85 into an array cable 93. Downlink and uplink optical fibers 16D, 16U in tether cables 95 of the array cables 93 are routed to each of the RAUs 14, as illustrated in FIG. 3B. The main cable 82 can include one or more multi-cable (MC) connectors adapted to connect select downlink and uplink optical fibers 16D, 16U, along with an electrical power line, to a number of optical fiber cables 86.

The main cable 82 enables multiple optical fiber cables 86 to be distributed throughout the building infrastructure 70 (e.g., fixed to the ceilings or other support surfaces of each floor 72, 74, 76) to provide the antenna coverage areas 80 for the first, second, and third floors 72, 74, and 76. In an example embodiment, the HEE 12 is located within the building infrastructure 70 (e.g., in a closet or control room), while in another example embodiment, the HEE 12 may be located outside of the building infrastructure 70 at a remote location. A base transceiver station (BTS) 88, which may be provided by a second party such as a cellular service provider, is connected to the HEE 12, and can be co-located or located remotely from the HEE 12. A BTS is any station or signal source that provides an input signal to the HEE 12 and can receive a return signal from the HEE 12.

In a typical cellular system, for example, a plurality of BTSs are deployed at a plurality of remote locations to provide wireless telephone coverage. Each BTS serves a corresponding cell and when a mobile client device enters the cell, the BTS communicates with the mobile client device. Each BTS can include at least one radio transceiver for enabling communication with one or more subscriber units operating within the associated cell. As another example, wireless repeaters or bi-directional amplifiers could also be used to serve a corresponding cell in lieu of a BTS. Alternatively, radio input could be provided by a repeater, picocell or femtocell as other examples.

The optical fiber-based distributed antenna system 10 in FIGS. 1-3B and described above provides point-to-point communications between the HEE 12 and the RAU 14. A multi-point architecture is also possible as well. With regard to FIGS. 1-3B, each RAU 14 communicates with the HEE 12 over a distinct downlink and uplink optical fiber pair to provide the point-to-point communications. Whenever an RAU 14 is installed in the optical fiber-based distributed antenna system 10, the RAU 14 is connected to a distinct downlink and uplink optical fiber pair connected to the HEE 12. The downlink and uplink optical fibers 16D, 16U may be provided in a fiber optic cable. Multiple downlink and uplink optical fiber pairs can be provided in a fiber optic cable to service multiple RAUs 14 from a common fiber optic cable.

For example, with reference to FIG. 3A, RAUs 14 installed on a given floor 72, 74, or 76 may be serviced from the same optical fiber 16. In this regard, the optical fiber 16 may have multiple nodes where distinct downlink and uplink optical fiber pairs can be connected to a given RAU 14. One downlink optical fiber 16D could be provided to support multiple channels each using wavelength-division multiplexing (WDM), as discussed in U.S. patent application Ser. No. 12/892,424 entitled “Providing Digital Data Services in Optical Fiber-based Distributed Radio Frequency (RF) Communications Systems, And Related Components and Methods,” incorporated herein by reference in its entirety. Other options for WDM and frequency-division multiplexing (FDM) are also disclosed in U.S. patent application Ser. No. 12/892,424, any of which can be employed in any of the embodiments disclosed herein.

The HEE 12 may be configured to support any frequencies desired, including but not limited to US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink).

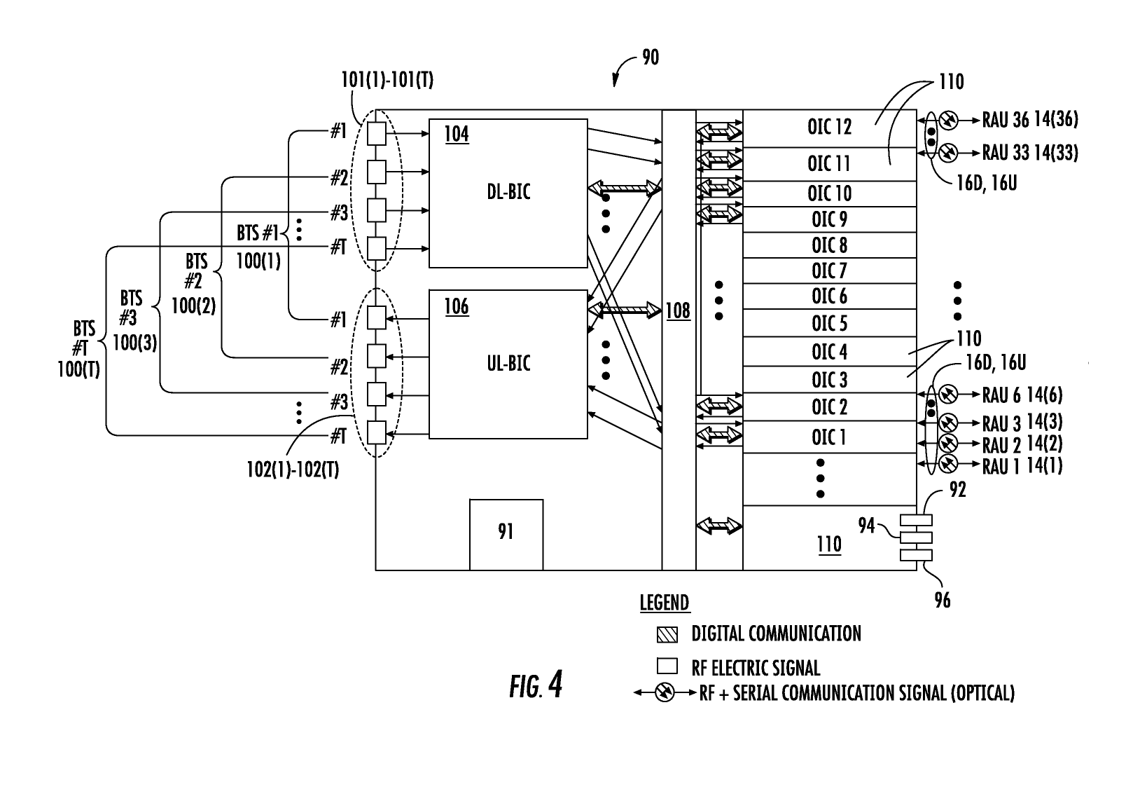

FIG. 4 is a schematic diagram of exemplary HEE 90 that may be employed with any of the distributed antenna systems disclosed herein, including but not limited to the optical fiber-based distributed antenna system 10 in FIGS. 1-3. The HEE 90 in this embodiment is configured to distribute RF communication services over optical fiber. In this embodiment as illustrated in FIG. 4, the HEE 90 includes a head-end controller (HEC) 91 that manages the functions of the HEE 90 components and communicates with external devices via interfaces, such as an RS-232 port 92, a Universal Serial Bus (USB) port 94, and an Ethernet port 96, as examples. The HEE 90 can be connected to a plurality of BTSs, transceivers 100(1)-100(T), and the like via BTS inputs 101(1)-101(T) and BTS outputs 102(1)-102(T). The notation “1-T” indicates that any number of BTS transceivers can be provided up to T number with corresponding BTS inputs and BTS outputs.

With continuing reference to FIG. 4, the BTS inputs 101(1)-101(T) are downlink connections and the BTS outputs 102(1)-102(T) are uplink connections. Each BTS input 101(1)-101(T) is connected to a downlink radio interface in the form of a downlink BTS interface card (BIC) 104 in this embodiment, which is located in the HEE 90, and each BTS output 102(1)-102(T) is connected to a radio interface in the form of an uplink BIC 106 also located in the HEE 90. The downlink BIC 104 is configured to receive incoming or downlink RF signals from the BTS inputs 101(1)-101(T) and split the downlink RF signals into copies to be communicated to the RAUs 14, as illustrated in FIG. 2. In this embodiment, thirty-six (36) RAUs 14(1)-14(36) are supported by the HEE 90, but any number of RAUs 14 may be supported by the HEE 90. The uplink BIC 106 is configured to receive the combined outgoing or uplink RF signals from the RAUs 14 and split the uplink RF signals into individual BTS outputs 102(1)-102(T) as a return communication path.

With continuing reference to FIG. 4 the downlink BIC 104 is connected to a midplane interface card 108 in this embodiment. The uplink BIC 106 is also connected to the midplane interface card 108. The downlink BIC 104 and uplink BIC 106 can be provided in printed circuit boards (PCBs) that include connectors that can plug directly into the midplane interface card 108. The midplane interface card 108 is in electrical communication with a plurality of optical interfaces provided in the form of optical interface cards (OICs) 110 in this embodiment, which provide an optical to electrical communication interface and vice versa between the RAUs 14 via the downlink and uplink optical fibers 16D, 16U and the downlink BIC 104 and uplink BIC 106. The OICs 110 include the E/O converter 28 like discussed with regard to FIG. 1 that converts electrical RF signals from the downlink BIC 104 to optical RF signals, which are then communicated over the downlink optical fibers 16D to the RAUs 14 and then to client devices. The OICs 110 also include the O/E converter 36 like in FIG. 1 that converts optical RF signals communicated from the RAUs 14 over the uplink optical fibers 16U to the HEE 90 and then to the BTS outputs 102(1)-102(T).

With continuing reference to FIG. 4, the OICs 110 in this embodiment support up to three (3) RAUs 14 each. The OICs 110 can also be provided in a PCB that includes a connector that can plug directly into the midplane interface card 108 to couple the links in the OICs 110 to the midplane interface card 108. The OICs 110 may consist of one or multiple optical interface modules (OIMs). In this manner, the HEE 90 is scalable to support up to thirty-six (36) RAUs 14 in this embodiment since the HEE 90 can support up to twelve (12) OICs 110. If less than thirty-six (36) RAUs 14 are to be supported by the HEE 90, less than twelve (12) OICs 110 can be included in the HEE 90 and plugged into the midplane interface card 108. One OIC 110 is provided for every three (3) RAUs 14 supported by the HEE 90 in this embodiment. OICs 110 can also be added to the HEE 90 and connected to the midplane interface card 108 if additional RAUs 14 are desired to be supported beyond an initial configuration. With continuing reference to FIG. 4, the HEU 91 can also be provided that is configured to be able to communicate with the downlink BIC 104, the uplink BIC 106, and the OICs 110 to provide various functions, including configurations of amplifiers and attenuators provided therein.

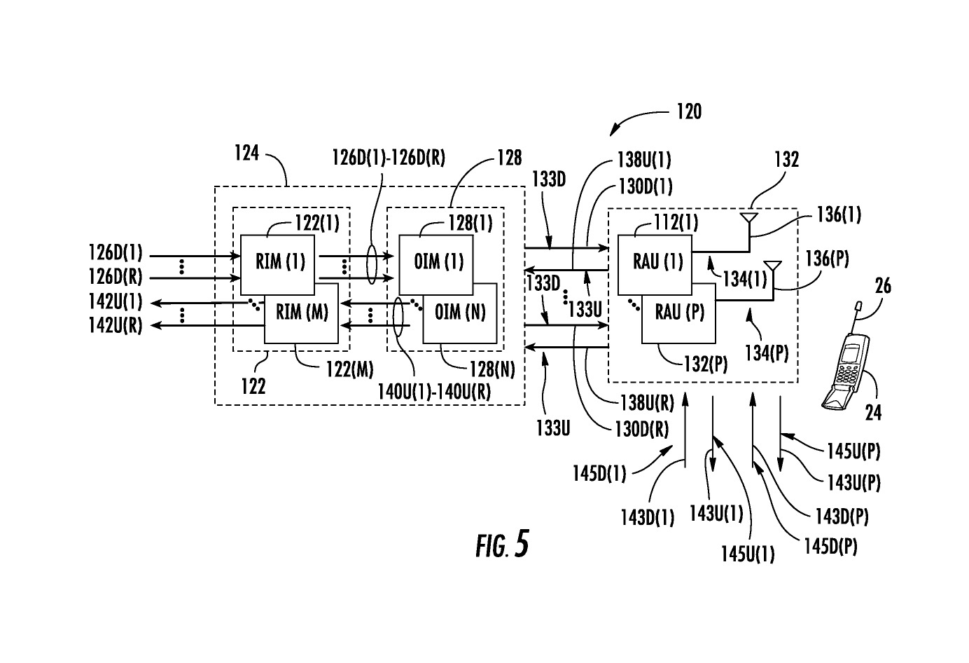

FIG. 5 is a schematic diagram of another exemplary optical fiber distributed antenna system 120 that may be employed according to the embodiments disclosed herein to provide RF communication services. In this embodiment, the optical fiber-based distributed antenna system 120 includes optical fiber for distributing RF communication services. The optical fiber-based distributed antenna system 120 in this embodiment is comprised of three (3) main components. One or more radio interfaces provided in the form of radio interface modules (RIMs) 122(1)-122(M) in this embodiment are provided in HEE 124 to receive and process downlink electrical RF communications signals 126D(1)-126D(R) prior to optical conversion into downlink optical RF communications signals. The RIMs 122(1)-122(M) provide both downlink and uplink interfaces. The processing of the downlink electrical RF communications signals 126D(1)-126D(R) can include any of the processing previously described above in the HEE 12 in FIGS. 1-4. The notations “1-R” and “1-M” indicate that any number of the referenced component, 1-R and 1-M, respectively, may be provided. As will be described in more detail below, the HEE 124 is configured to accept a plurality of RIMs 122(1)-122(M) as modular components that can easily be installed and removed or replaced in the HEE 124. In one embodiment, the HEE 124 is configured to support up to eight (8) RIMs 122(1)-122(M).

Each RIM 122(1)-122(M) can be designed to support a particular type of radio source or range of radio sources (i.e., frequencies) to provide flexibility in configuring the HEE 124 and the optical fiber-based distributed antenna system 120 to support the desired radio sources. For example, one RIM 122 may be configured to support the Personal Communication Services (PCS) radio band. Another RIM 122 may be configured to support the 700 MHz radio band. In this example, by inclusion of these RIMs 122, the HEE 124 would be configured to support and distribute RF communications signals on both PCS and LTE 700 radio bands. RIMs 122 may be provided in the HEE 124 that support any frequency bands desired, including but not limited to the US Cellular band, Personal Communication Services (PCS) band, Advanced Wireless Services (AWS) band, 700 MHz band, Global System for Mobile communications (GSM) 900, GSM 1800, and Universal Mobile Telecommunication System (UMTS). RIMs 122 may be provided in the HEE 124 that support any wireless technologies desired, including but not limited to Code Division Multiple Access (CDMA), CDMA200, 1xRTT, Evolution-Data Only (EV-DO), UMTS, High-speed Packet Access (HSPA), GSM, General Packet Radio Services (GPRS), Enhanced Data GSM Environment (EDGE), Time Division Multiple Access (TDMA), Long Term Evolution (LTE), iDEN, and Cellular Digital Packet Data (CDPD).

RIMs 122 may be provided in the HEE 124 that support any frequencies desired, including but not limited to US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink).

The downlink electrical RF communications signals 126D(1)-126D(R) are provided to a plurality of optical interfaces provided in the form of optical interface modules (OIMs) 128(1)-128(N) in this embodiment to convert the downlink electrical RF communications signals 126D(1)-126D(N) into downlink optical RF communications signals 130D(1)-130D(R). The notation “1-N” indicates that any number of the referenced component 1-N may be provided. The OIMs 128 may be configured to provide one or more optical interface components (OICs) that contain O/E and E/O converters, as will be described in more detail below. The OIMs 128 support the radio bands that can be provided by the RIMs 122, including the examples previously described above. Thus, in this embodiment, the OIMs 128 may support a radio band range from 400 MHz to 2700 MHz, as an example, so providing different types or models of OIMs 128 for narrower radio bands to support possibilities for different radio band-supported RIMs 122 provided in the HEE 124 is not required. Further, as an example, the OIMs 128 may be optimized for sub-bands within the 400 MHz to 2700 MHz frequency range, such as 400-700 MHz, 700 MHz-1 GHz, 1 GHz-1.6 GHz, and 1.6 GHz-2.7 GHz, as examples.

The OIMs 128(1)-128(N) each include E/O converters to convert the downlink electrical RF communications signals 126D(1)-126D(R) to downlink optical RF communications signals 130D(1)-130D(R). The downlink optical RF communications signals 130D(1)-130D(R) are communicated over downlink optical fiber(s) 133D(1) to a plurality of RAUs 132(1)-132(P). The notation “1-P” indicates that any number of the referenced component 1-P may be provided. O/E converters provided in the RAUs 132(1)-132(P) convert the downlink optical RF communications signals 130D(1)-130D(R) back into downlink electrical RF communications signals 126D(1)-126D(R), which are provided over downlinks 134(1)-134(P) coupled to antennas 136(1)-136(P) in the RAUs 132(1)-132(P) to client devices in the reception range of the antennas 136(1)-136(P).

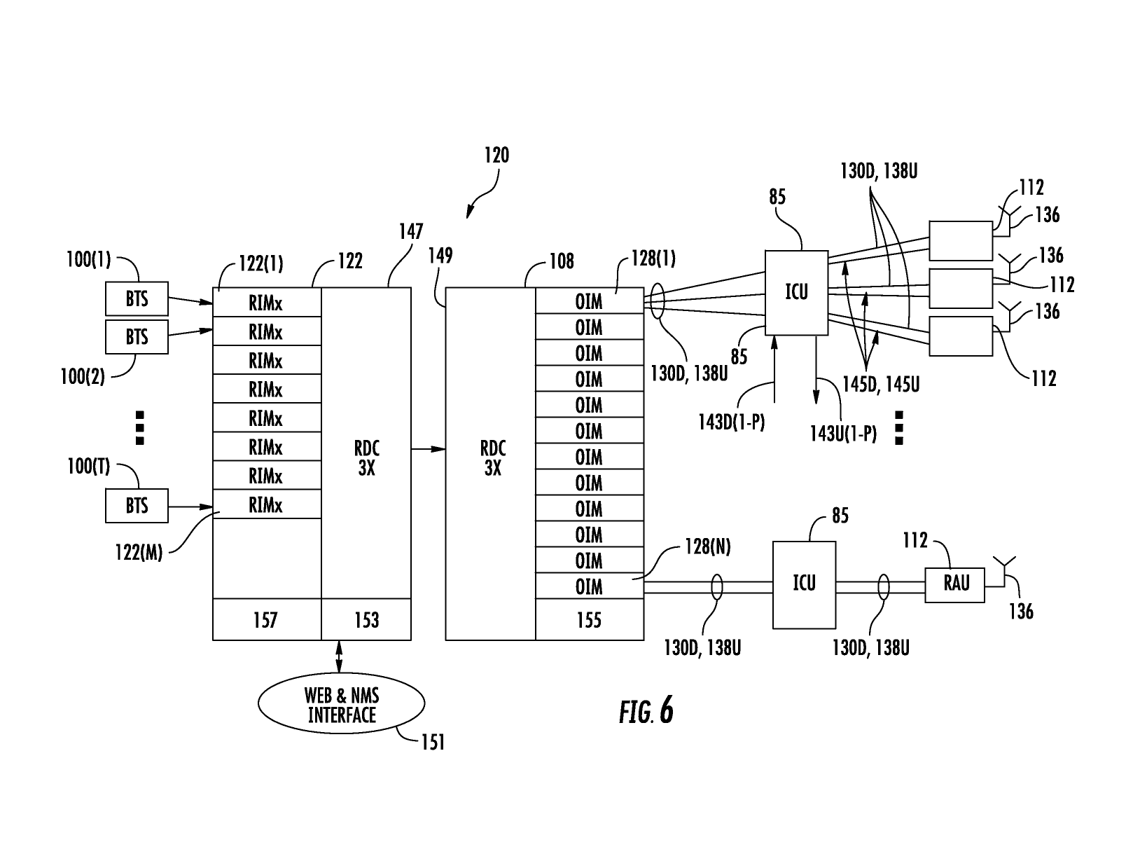

E/O converters are also provided in the RAUs 132(1)-132(P) to convert uplink electrical RF communications signals 126U(1)-126U(R) received from client devices through the antennas 136(1)-136(P) into uplink optical RF communications signals 138U(1)-138U(R) to be communicated over uplink optical fibers 133U to the OIMs 128(1)-128(N). The OIMs 128(1)-128(N) include O/E converters that convert the uplink optical RF communications signals 138U(1)-138U(R) into uplink electrical RF communications signals 140U(1)-140U(R) that are processed by the RIMs 122(1)-122(M) and provided as uplink electrical RF communications signals 142U(1)-142U(R). Downlink electrical digital signals 143D(1)-143D(P) communicated over downlink electrical medium or media (hereinafter “medium”) 145D(1)-145D(P) are provided to the RAUs 132(1)-132(P), such as from a digital data services (DDS) controller and/or DDS switch as provided by example in FIG. 5, separately from the RF communication services, as well as uplink electrical digital signals 143U(1)-143U(P) communicated over uplink electrical medium 145U(1)-145U(P), as also illustrated in FIG. 6. Common elements between FIG. 5 and FIG. 6 are illustrated in FIG. 6 with common element numbers. Power may be provided in the downlink and/or uplink electrical medium 145D(1)-145D(P) and/or 145U(1)-145U(P) to the RAUs 132(1)-132(P).

In one embodiment, up to thirty-six (36) RAUs 112 can be supported by the OIMs 128, three RAUs 112 per OIM 128 in the optical fiber-based distributed antenna system 120 in FIG. 5. The optical fiber-based distributed antenna system 120 is scalable to address larger deployments. In the illustrated optical fiber-based distributed antenna system 120: the HEE 124 is configured to support up to thirty six (36) RAUs 112 and fit in 6 U rack space (U unit meaning 1.75 inches of height). The downlink operational input power level can be in the range of −15 dBm to 33 dBm. The adjustable uplink system gain range can be in the range of +15 dB to −15 dB. The RF input interface in the RIMs 122 can be duplexed and simplex, N-Type. The optical fiber-based distributed antenna system can include sectorization switches to be configurable for sectorization capability, as discussed in U.S. patent application Ser. No. 12/914,585 filed on Oct. 28, 2010, and entitled “Sectorization In Distributed Antenna Systems, and Related Components and Method,” which is incorporated herein by reference in its entirety.

In another embodiment, an exemplary RAU 112 may be configured to support up to four (4) different radio bands/carriers (e.g. ATT, VZW, TMobile, Metro PCS: 700LTE/850/1900/2100). Radio band upgrades can be supported by adding remote expansion units over the same optical fiber (or upgrade to MIMO on any single band), as will be described in more detail below starting with FIG. 7. The RAUs 112 and/or remote expansion units may be configured to provide external filter interface to mitigate potential strong interference at 700 MHz band (Public Safety, CH51,56); Single Antenna Port (N-type) provides DL output power per band (Low bands (<1 GHz): 14 dBm, High bands (>1 GHz): 15 dBm); and satisfies the UL System RF spec (UL Noise Figure: 12 dB, UL IIP3: −5 dBm, UL AGC: 25 dB range).

FIG. 6 is a schematic diagram of providing digital data services and RF communication services to RAUs and/or other remote communications units in the optical fiber-based distributed antenna system 120 of FIG. 6. Common components between FIGS. 5 and 6 and other figures provided have the same element numbers and thus will not be re-described. As illustrated in FIG. 6, a power supply module (PSM) 153 may be provided to provide power to the RIMs 122(1)-122(M) and radio distribution cards (RDCs) 147 that distribute the RF communications from the RIMs 122(1)-122(M) to the OIMs 128(1)-128(N) through RDCs 149. In one embodiment, the RDCs 147, 149 can supports different sectorization needs. A PSM 155 may also be provided to provide power the OIMs 128(1)-128(N). An interface 151, which may include web and network management system (NMS) interfaces, may also be provided to allow configuration and communication to the RIMs 122(1)-122(M) and other components of the optical fiber-based distributed antenna system 120. A microcontroller, microprocessor, or other control circuitry, called a head-end controller (HEC) 157 may be included in HEE 124 (FIG. 7) to provide control operations for the HEE 124.

The exemplary optical fiber-based distributed antenna systems described above in FIGS. 1-6 may have limitations on performance (i.e., data rate) based on the particular components and configurations chosen for the system. It may be desired to be able to improve communications performance of optical fiber-based distributed antenna systems as the needs for the system increase over time. The data rate needs for the system may increase after initial installation as an example. It may be desirable to be able to increase the data rate of an optical fiber-based distributed antenna system without requiring additional bandwidth or transmit power.

In this regard, embodiments disclosed below starting at FIG. 7 include optical fiber-based distributed antenna systems that support multiple-input, multiple-output (MIMO) antenna configurations and communications. MIMO communications configurations involve the use of multiple antennas at both the transmitter and a receiver to improve communications performance. MIMO can offer significant increases in data communications rates without requiring additional bandwidth or transmit power by higher spectral efficiency (i.e., more data per second per hertz of bandwidth) ad link reliability or diversity to reduce fading. Embodiments disclosed herein also include optical fiber-based distributed antenna system that can be flexibly configured to support or not support MIMO communications configurations. When configured to support MIMO communications configurations, the optical fiber-based distributed antenna systems are provided that allow for MIMO configurations with existing components.

In this regard in one embodiment, FIG. 7 is a schematic diagram illustrating an exemplary single band MIMO upgrade for one reconfigured RAU 112(1)′ in an optical fiber-based distributed antenna system 120′ employing components in the optical fiber-based distributed antenna system 120 in FIG. 4. This configuration can provide mixed single-input, single-output (SISO) configurations with MIMO as well. Common components are signified by common element numbers. Note that the upgrade can be provided for any of the RAUs 112 and not just RAU 112(1)′. In this example, the upgrade (e.g., LTE, HSPA+) provides an expansion option for additional band or single band MIMO employing a remote unit in the form of a remote expansion unit (RXU) 170 employing a separate antenna 172 coupled to the RAU 112(1)′. The RXU 170 contains similar components to the RAU 112(1)′, including optical-to-electrical and electrical-to-optical converters. The RAU 112(1)′ provides a first communication path with a first RIM 122(1) (also referred to herein as the “main RIM 122(1)”) for a MIMO configuration. The RXU 170 provides a second communication path with a second RIM 122(M+1) supporting the same radio band as the main RIM 122(1).

Although two communications paths are provided—one for the RAU 112(1)′ and one for the RXU 170, the RXU 170 receives RF communications signals from RIM 122(M+1) via the same optical fiber pair 133D(1), 133U(1) as the RIM 122(1) receives RF communications signals from the main RIM 122(1). In this manner, the same optical fiber pair 133D(1), 133U(1) is used to provide multiple paths for MIMO communications for a given radio band and communication session. Thus, the overall capacity of RAUs 112 in the optical fiber-based distributed antenna system 120′ is not reduced, because optical fiber pairs 133D, 133U are not consumed to provide this MIMO configuration.

As will be discussed in more detail below, to provide this MIMO configuration, the RIM 122(M+1) converts or shifts the frequency of received downlink electrical RF communications signals 126D(R+1) at the MIMO band to a different frequency before distributing the signal on the downlink to the RDCs 147, 149 and the OIM 128(1) over the optical fiber pair 133D(1), 133U(1). In this manner, the frequencies of the signals for the two communication paths for the MIMO configuration do not interfere with each other when being communicated over the downlink optical fiber 133D(1). At the RXU 170, the downlink optical RF communications signals 130D(1) from the RIM 122(M+1)′ are received via the RIM 122(1)′ over the downlink optical fiber 176D. The downlink optical RF communications signals 130D(1) from the RIM 122(M+1)′ are converted back to the original frequency of the radio band configured for MIMO before being transmitted as downlink electrical RF communications signals 174D through antenna 172.

Similarly for the uplink, the RXU 170 converts or shifts the frequency of received uplink electrical RF communications signals 174U from antenna 172 to a different frequency before distributing the RF communications signals as uplink optical RF communications signals 138U(1) on the uplink optical fiber 176U from the RXU 170 to the RIM 122(1). The uplink optical RF communications signals 138U(1) on the uplink optical fiber 176U are sent on the uplink optical RF communications fiber 138U(1) back to the HEE 124 and to the RIM 122(M+1)′. The RIM 122(M+1)′ converts or shifts the frequency back to the original radio band/frequency configured for MIMO before distributing the signals as uplink electrical RF communications signals 126U(R+1). As will also be described in more detail below, power for the RXU 170 can also be provided from the main RAU 112(1)′ so that the RXU does not have to employ a separate power source. The RXU 170 and RAU 112(1) may be co-located, including but not limited to being with a distance of each other within less than or equal to 20 meters, or less than or equal to 15 meters, or less than or equal to 10 meters, or less than or equal to 5 meters, or less than or equal to 3 meters, or less than or equal to 1 meter, as non limiting examples.

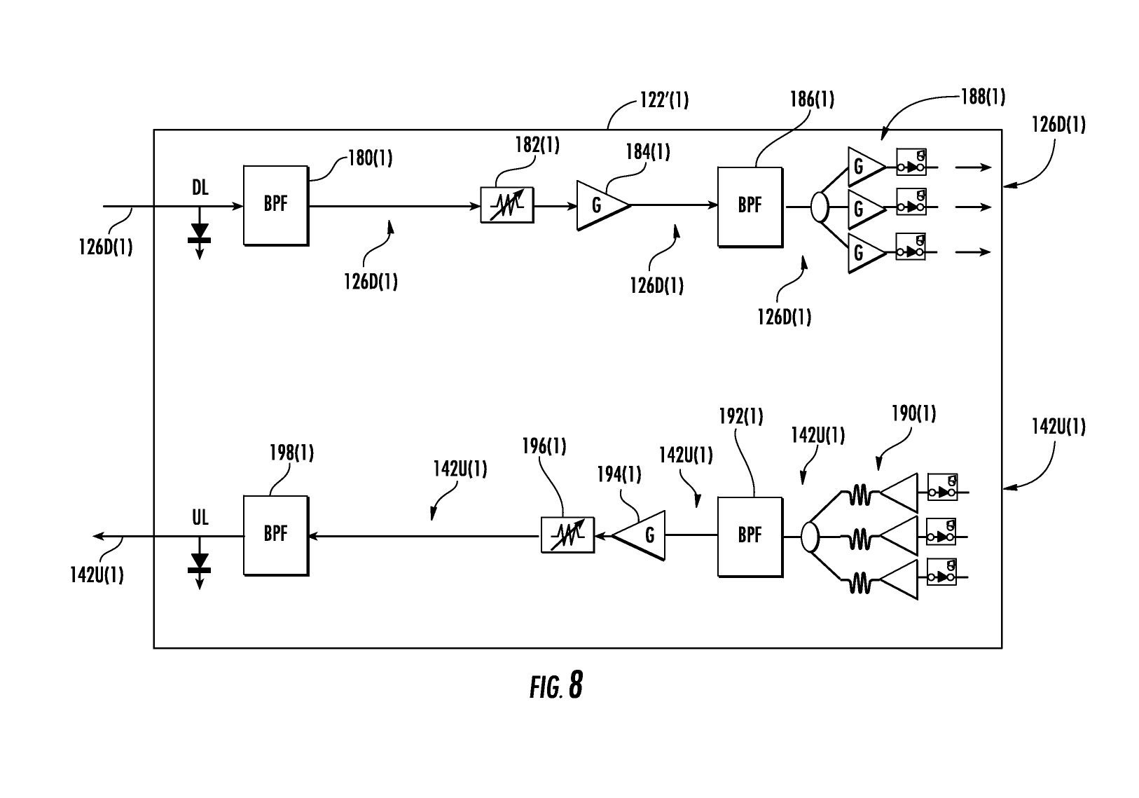

FIG. 8 is a schematic diagram of the main RIM 122(1)′ employed in the HEE 124 for the first communication path in the MIMO configuration in the distributed optical fiber-based distributed antenna system 120′ in FIG. 7. The main RIM 122(1)′ in this embodiment and as illustrated in FIG. 8 needs no special configuration or components as compared to the RIMs described in regard to FIG. 5 above. The components described herein with regard to the main RIM 122(1)′ are provided in the other RIMs 122 in FIG. 5 in this embodiment. In this regard with reference to FIG. 8, the downlink electrical RF communications signals 126D(1) come into the downlink of the main RIM 122(1)′ on a first downlink communication path for the MIMO configuration. A band pass filter (BPF) 180(1) is provided that filters the downlink electrical RF communications signals 126D(1) according to the radio band configured to be supported by the main RIM 122(1)′. In this embodiment, this BPF 180(1) is configured to filter radio band signals according to the radio band configured for MIMO in the optical fiber-based distributed antenna system 120′.

With continuing reference to FIG. 8, the filtered downlink electrical RF communications signals 126D(1) are then passed through an attenuator 182(1), a gain amplifier 184(1), and another BPF 186(1) to provide additional gain control and filtering according to configuration and/or settings for the main RIM 122(1)′. Thereafter, the downlink electrical RF communications signals 126D(1) can be split into up to three sectors via sectorization switches 188(1) to provide the downlink electrical RF communications signals 126D(1), via conversion to downlink optical RF communications signals by the OIMs 128(1) (see FIG. 7), to desired sectors. More information on sectorization that can be employed herein is discussed in U.S. patent application Ser. No. 12/914,585 previously referenced above.

Similarly, with regard to the uplink communication path, with continuing reference to FIG. 8, uplink electrical RF communications signals 142U(1) come from the OIM 128(1) (see FIG. 7) into the uplink of the main RIM 122(1)′ on a first uplink communication path for the MIMO configuration. Sectorization switches 190(1) control the distribution of the uplink electrical RF communications signals 142U(1) to the uplink of the main RIM 122(1)′. More information on sectorization that can be employed herein is discussed in U.S. patent application Ser. No. 12/914,585 previously referenced above. A band pass filter (BPF) 192(1) is provided that filters the uplink electrical RF communications signals 142U(1) according to the radio band configured to be supported by the main RIM 122(1)′. In this embodiment, this BPF 192(1) is configured to filter radio band signals according to the radio band configured for MIMO in the optical fiber-based distributed antenna system 120′. The filtered uplink electrical RF communications signals 142U(1) are then passed through a gain amplifier 194(1), an attenuator 196(1), and another BPF 198(1) to provide additional gain control and filtering according to configuration and/or settings for the main RIM 122(1)′.

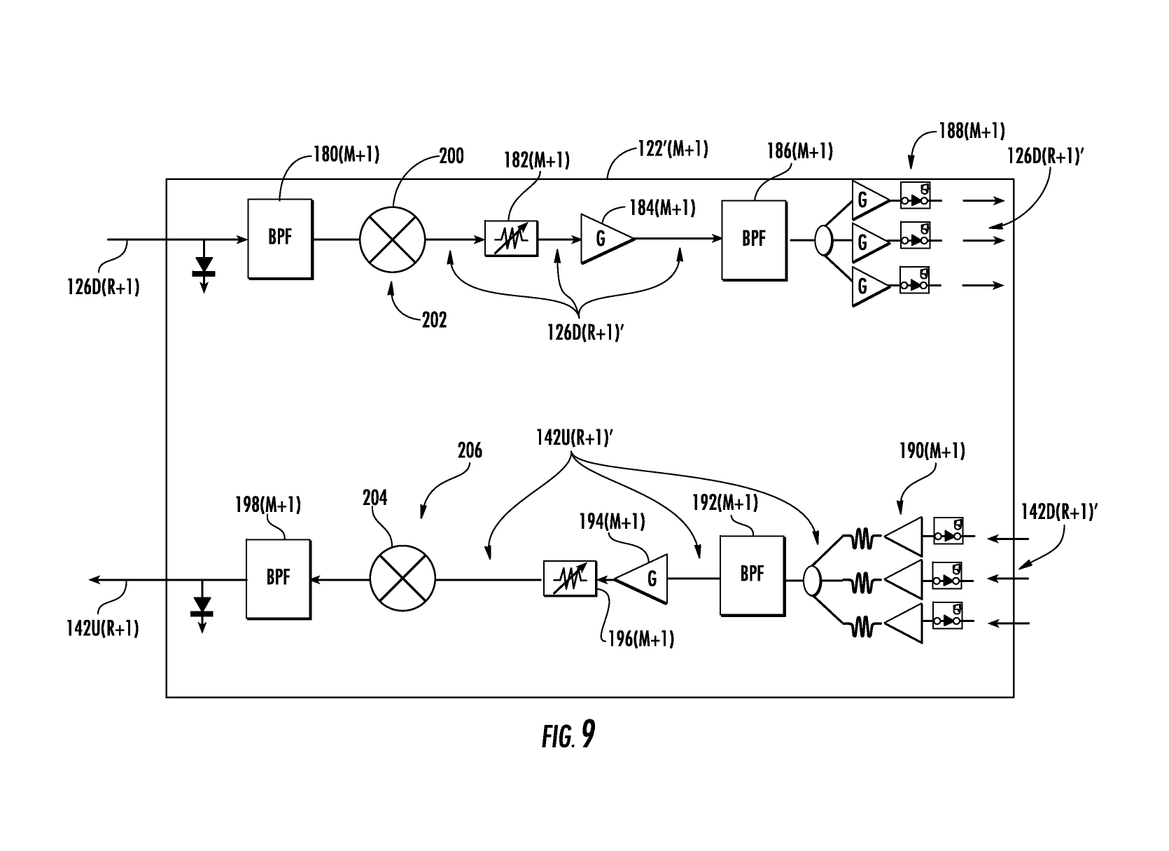

FIG. 9 is a schematic diagram of the second RIM 122(M+1)′ employed in the HEE 124 for the second communication path in the MIMO configuration in the distributed optical fiber-based distributed antenna system 120′ in FIG. 7. The downlink electrical RF communications signals 126D(R+1) come into the downlink of the second RIM 122(M+1)′ on a second downlink communication path for the MIMO configuration. A band pass filter (BPF) 180(M+1) is provided that filters the downlink electrical RF communications signals 126D(R+1) according to the radio band configured to be supported by the second RIM 122(R+1)′. In this embodiment, this BPF 180(M+1) is configured to filter radio band signals according to the radio band configured for MIMO in the optical fiber-based distributed antenna system 120′, which in this embodiment is the radio band configured to be supported by the main RIM 122(1)′. A frequency converter 200 in the form of a mixer is provided to convert the frequency of the downlink electrical RF communications signals 126D(R+1) to a different frequency that the native frequency supported by the second RIM 122(M+1)′ to provide downlink electrical RF communications signals 126D(R+1)′. A local oscillator signal 202 with phase locked-loop (PLL) circuitry generated and controlled based on a master synchronization signal (not shown) is provided to frequency converter 200, as is well known. In this manner, the frequency of the downlink electrical RF communications signals 126D(R+1)′ does not interfere with the downlink electrical RF communications signals 126D(1) from the main RIM 122(1)′ when both signals are provided on the same single optical fiber 133D(1) to the RAU 112(1)′, as illustrated in FIG. 7.

With continuing reference to FIG. 9, the downlink electrical RF communications signals 126D(R+1)′ are then passed through an attenuator 182(M+1), a gain amplifier 184(M+1), and another BPF 186(M+1) to provide additional gain control and filtering according to configuration and/or settings for the second RIM 122(M+1)′. Thereafter, the downlink electrical RF communications signals 126D(1) can be split into up to three sectors via sectorization switches 188(M+1) to provide the downlink electrical RF communications signals 126D(1), via conversion to downlink optical RF communications signals by the OIMs 128(1) (see FIG. 7), to desired sectors. More information on sectorization that can be employed herein is discussed in U.S. patent application Ser. No. 12/914,585 previously referenced above.

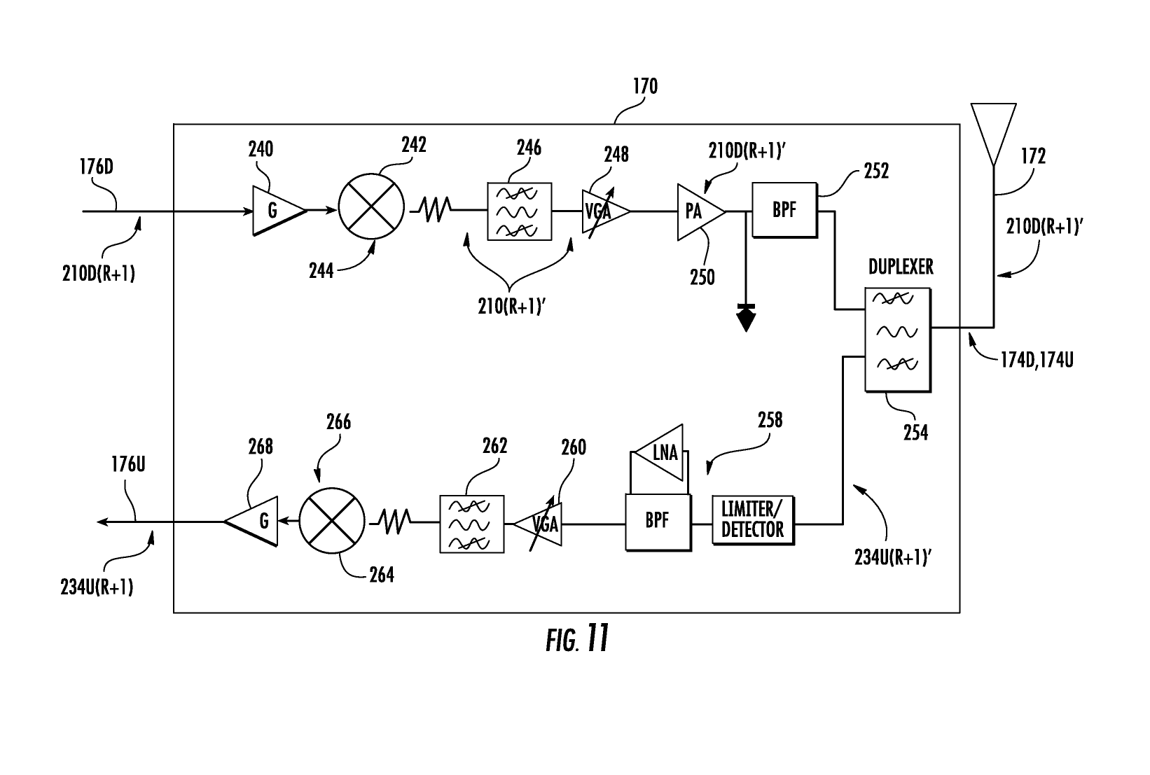

Similarly, with regard to the uplink communication path, with continuing reference to FIG. 9, uplink electrical RF communications signals 142U(R+1)′ come from the OIM 128(1) (see FIG. 7) into the uplink of the second RIM 122(M+1)′ on a second uplink communication path for the MIMO configuration. As will be discussed below with regard to FIG. 11, the uplink electrical RF communications signals 142U(R+1)′ will be at the converted frequency and not the native frequency of the second RIM 122(M+1)′ and main RIM 122(1)′ for the MIMO configuration to avoid interference with uplink electrical RF communications signals 126U(1). Sectorization switches 190(M+1) control the distribution of the uplink electrical RF communications signals 142U(R+1)′ to the uplink of the main RIM 122(1)′. More information on sectorization that can be employed herein is discussed discussed in U.S. patent application Ser. No. 12/914,585 previously referenced above. A band pass filter (BPF) 192(M+1) is provided that filters the uplink electrical RF communications signals 142U(R+1)′ according to the conversion radio band configured to be supported by the second RIM 122(M+1)′. In this embodiment, this BPF 192(M+1) is configured to filter radio band signals according to the conversion radio band, not the radio band configured for MIMO in the optical fiber-based distributed antenna system 120′.

With continuing reference to FIG. 9, the uplink electrical RF communications signals 142U(R+1)′ are passed through a frequency converter 204 to convert the frequency of the uplink electrical RF communications signals 142U(R+1)′ back to the radio band configured for the MIMO configuration to provide uplink electrical RF communications signals 142U(R+1). The converted uplink electrical RF communications signals 142U(R+1) are then passed through another BPF 198(M+1) to provide additional filtering according to configuration and/or settings for the second RIM 122(M+1)′.

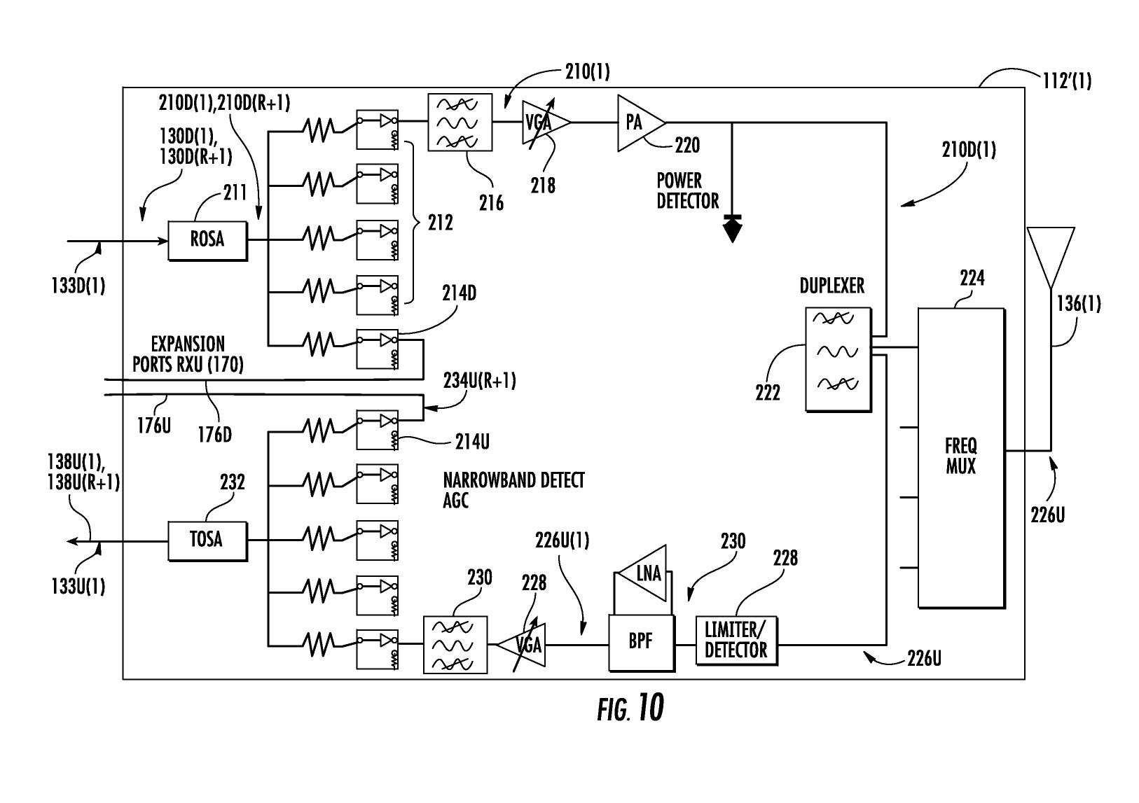

FIG. 10 is a schematic diagram of the RAU 112(1)′ configured to distribute RF communications signals for the first communication path in the MIMO configuration in the optical fiber-based distributed antenna system 120′ in FIG. 7. In this regard, the downlink electrical RF communications signals 126D(1), 126D(R+1)′ from the main RIM 122(1)′ and second RIM 122(M+1)′ in FIGS. 8 and 9, respectively, come into the downlink of the RAU 112(1)′ on a downlink communication path for the MIMO configuration as downlink optical RF communications signals 130D(1), 130D(R+1). The downlink electrical RF communications signals 126D(1), 126D(R+1)′ were converted to the downlink optical RF communications signals 130D(1), 130D(R+1) in the OIM 128(1) (see FIG. 7). The downlink optical RF communications signals 130D(1), 130D(R+1) are converted into downlink electrical RF communications signals 210D(1), 210D(R+1) in a receive optical sub-assembly (ROSA) 211, which is an optical-to-electrical converter. The downlink electrical RF communications signals 210D(1), 210D(R+1) are split into four (4) paths 212 in the RAU 112(1)′, which is configured to support up to four (4) radio bands in this embodiment, one of which will be the first communication path for the MIMO configuration. One of the paths 212 is fully illustrated in FIG. 10, described below. The downlink electrical RF communications signals 210D(1), 210D(R+1) are also split to an downlink expansion port 214D that is coupled to the RXU 170 (see FIG. 7) to provide the second communication path for the MIMO configuration, which will be described in more detail in FIG. 11 below.

With reference back to FIG. 10, the first communication path for the MIMO configuration in the RAU 112(1)′ includes a band pass filter (BPF) 216 is provided that filters the downlink electrical RF communications signals 210D(1), 210D(R+1) according to the radio band configured to be supported by the main RIM 122(1)′. In this embodiment, this BPF 180(1) is configured to filter radio band signals according to the radio band configured for MIMO in the optical fiber-based distributed antenna system 120′, which will pass downlink electrical RF communications signals 210D(1) and not downlink electrical RF communications signals 210D(R+1). The filtered downlink electrical RF communications signals 210D(1) are then passed through an variable gain amplifier 218, a power amplifier 220, and a diplexer 222 coupled to a frequency multiplexer 224 (since the RAU 112(1)′ is configured to support multiple radio bands) to communicate the downlink electrical RF communications signals 210D(1) through antenna 136(1).

With continuing reference to FIG. 10, uplink electrical RF communications signals 226U received from the antenna 136(1) come into the RAU 112(1)′. A limiter/detector 228 and filter 230 are provided in the communication path to filter the uplink electrical RF communications signals 226U(1) to the radio band signals configured for the MIMO configuration. The filtered uplink electrical RF communications signals 226U(1) are then passed through an variable gain amplifier 228, a power amplifier 230 to a transmit optical sub-assembly (TOSA) 232, which is an electrical-to-optical converter. Uplink electrical RF communications signals 234U(R+1) received by the RXU 170 at the radio band configured for MIMO, are received at a converted frequency (through frequency conversion in the RXU 170 discussed in FIG. 11 below) through the uplink expansion port 214U in the RIM 122(1)′. The uplink electrical RF communications signals 234U(1), 234U(R+1) are combined and provided to the TOSA to be converted to uplink optical RF communications signals 138U(1), 138U(R+1) and communicated over the single uplink optical fiber 133U(1) to the main RIM 122(1)′ and the second RIM 122(M+1)′, respectively. As discussed above in FIG. 9, the second RIM 122(M+1)′ includes the frequency converter 206 that converts the frequency of the uplink electrical RF communications signals 234U(R+1) to the radio band configured for MIMO.

FIG. 11 is a schematic diagram of the RXU 170 in FIG. 7 coupled to the RAU 112(1)′ in FIG. 10, configured to distribute RF communications signals for the second communication path in the MIMO configuration in the distributed optical fiber-based distributed antenna system 120′ in FIG. 7. The downlink electrical RF communications signals 210D(R+1) come into the downlink of the second RIM 122(M+1)′ on a second downlink communication path for the MIMO configuration via the downlink optical fiber 176D from the downlink expansion port 214D in the RAU 112(1)′, as illustrated in FIG. 10 and described above. The downlink electrical RF communications signals 210D(R+1) passes through a gain amplifier 240 and to a frequency converter 242 in the form of a mixer to convert the frequency of the downlink electrical RF communications signals 210D(R+1) back to the native frequency supported by the second RIM 122(M+1)′ to provide downlink electrical RF communications signals 210D(R+1)′. A local oscillator signal 244 with phase locked-loop (PLL) circuitry generated and controlled based on a master synchronization signal (not shown) is provided to frequency converter 242, as is well known. In this manner, the frequency of the downlink electrical RF communications signals 210D(R+1)′ is restored back to the radio band configured for MIMO for the second downlink communication path provided by the RXU 170. The downlink electrical RF communications signals 210D(R+1)′ are then passed through an BPF 246, an attenuator 248, a gain amplifier 250, and another BPF 252 to provide additional gain control and filtering according to configuration and/or settings for the RXU 170. Thereafter, the downlink electrical RF communications signals 210D(R+1)′ can be communicated through antenna 172 via the diplexer 254. More information on sectorization that can be employed herein is discussed in U.S. patent application Ser. No. 12/914,585 previously referenced above.

Similarly, with regard to the uplink communication path, with continuing reference to FIG. 11, uplink electrical RF communications signals 234U(R+1)′ at the native radio band configured for MIMO are received from the antenna 172 and diplexer 254 for the second uplink communication path for the MIMO configuration. The uplink electrical RF communications signals 234U(R+1)′ are passed through filtering system 258, a variable gain amplifier, and a BPF 262 to filter the uplink electrical RF communications signals 234U(R+1)′ according to the radio band configured for MIMO. The uplink electrical RF communications signals 234U(R+1)′ are then passed through a frequency converter 264 to convert the frequency of the uplink electrical RF communications signals 234U(R+1)′ to a different frequency than the radio band configured for the MIMO configuration to provide uplink electrical RF communications signals 234U(R+1). The converted uplink electrical RF communications signals 234U(R+1) are then passed through another gain amplifier 268 and onto the uplink optical fiber 176U to the uplink expansion port 214U in the RAU 112(1)′ in FIG. 10. The converted uplink electrical RF communications signals 234U(R+1) are then communicated from the RAU 112(1)′ in FIG. 10 to the OIM 128(1)′ over the common uplink optical fiber 133U and back to second RIM 122(M+1)′ to provide the second uplink communication path as previously discussed above.

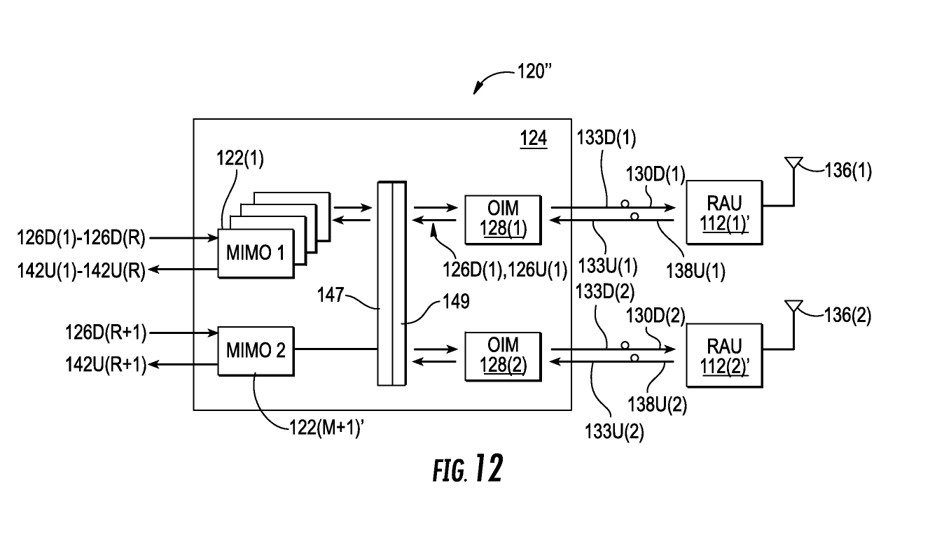

Providing other alternative MIMO configurations in the optical fiber-based distributed antenna system 120 in FIG. 7 is also possible. In this regard, FIG. 12 is a schematic diagram illustrating an alternative single band MIMO upgrade in an upgraded optical fiber-based distributed antenna system 120″, which includes components from the optical fiber-based distributed antenna system 120 in FIG. 5. Common components are shown with common element numbers. In this alternative optical fiber-based distributed antenna system 120″ in FIG. 12, a RXU is not employed. Instead, separate RAUs 112(1), 112(2) are used to provide the two communication paths for the MIMO configuration. In this regard, the same optical fiber is not shared for the downlink and uplink communication paths for both the main RIM 122(1) and the second RIM 122(M+1). The optical fiber-based distributed antenna system 120″ is configured, and specifically the RDCs 147, 149, so that main RIM 122(1) and the second RIM 122(M+1) distribute and receive signals from different OIMs 128(1), 128(2), respectively. This avoids frequency conversion for the second communication path and the associated components in the second RIM 122(M+1) and the need for the RXU 170, but it also reduces the overall RAU capacity of the optical fiber-based distributed antenna system 120″. This is because the second RAU 112(2)′ is employed in lieu of the RXU 170, thus consuming an additional RAU. The second RIM 122(M+1) may be configured like the second RIM 122(M+1)′ in FIGS. 7 and 9, except that frequency conversion components are not required. Similarly, the first and second RAUs 112(1), 112(2)′ maybe configured similar to the RAU 112(1) and RXU 170, respectively, except that no expansion port need be provided in the first RAU 112(1), and frequency conversion components are not required in the second RAU 112(2).

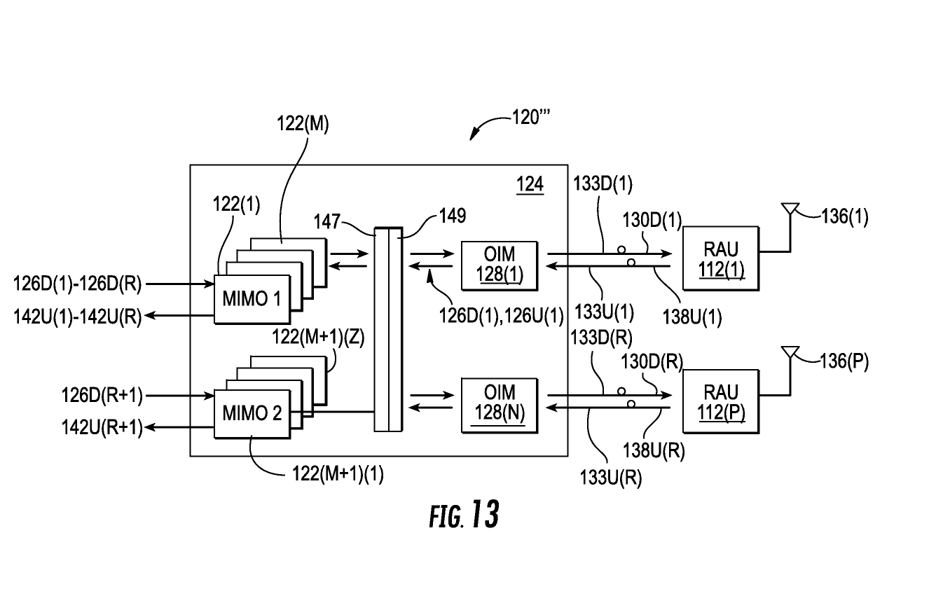

Multiple band MIMO configurations can also be provided and configured in the optical fiber-based distributed antenna system 120 in FIG. 7. It may be desired to provide MIMO communication configurations for more than one single radio band in the optical fiber-based distributed antenna system. For example, the optical-fiber based distributed antenna system 120 in FIG. 7 may be configured to support up to four (4) different radio bands depending on the configuration of the RIMs 122 provides in the HEE 194. In this regard, FIG. 13 is a schematic diagram illustrating an alternative multiple band MIMO upgrade in an upgraded optical fiber-based distributed antenna system 120′″, which includes components from the optical fiber-based distributed antenna system 120 in FIG. 5. Common components are shown with common element numbers. In this alternative optical fiber-based distributed antenna system 120′″ in FIG. 13, a RXU is not employed. Instead, similar to the optical fiber-based distributed antenna system 120″ in FIG. 12, separate RAUs 112 are used to provide separate multiple raiod band communication paths configured for MIMO. In this regard, the same optical fiber is not shared for the downlink and uplink communication paths for both main RIMs 122(1)-122(M) and the second RIMs 122(M+1)-122(M+1+Z) configured in MIMO configuration.

With continuing reference to FIG. 13, multiple main RIMs 122(1)-122(N) are configured in MIMO configuration to provide MIMO communications for multiple radio bands. For example, each main RIM 122(1)-122(M) may be configured to support a different radio band. Second RIMs 122(M+1)-122(M+1+Z) may be provided for the same radio bands configured for the main RIMs 122(1)-122(M) to provide multiple RIM 122 pairs at the multiple radio bands to provide multiple radio band communications paths for MIMO configuration. “Z” represents any number of second RIMs 122 up to the number of main RIMs 122 “M.” Any number of main and second RIM 122 pairs may be provided. Note that capacity of supported RIMs 122 may be reduced in this configuration if RIM 122 capacity is not increased in the HEE 194. This is one of the possible tradeoffs, as discussed above, with regard to providing separate communication paths for the multiple radio band communications paths in MIMO configuration, as opposed to provide the RXU 170 in FIG. 7.

With continuing reference to FIG. 13, the optical fiber-based distributed antenna system 120′″ is configured, and specifically the RDCs 147, 149, so that main RIMs 122(1)-122(M) and their corresponding second RIM 122(M+1), 122(M+1+Z) distribute and receive signals through different OIMs 128(1)-128(M), respectively. Distributing and receiving signals through different OIMs 128(1)-128(M) avoids frequency conversion for the second communication paths and the associated components in the second RIMs 122(M+1), 122(M+1+Z) and the need for the RXU 170. However, this configuration can also reduce the overall RAU capacity of the optical fiber-based distributed antenna system 120″. This is because the second RAU 112(P) is employed in lieu of the RXU 170, thus consuming an additional RAU 112.

With continuing reference to FIG. 13, the signals are distributed to multi-band RAUs 112(1), 112(P), meaning that each RAU 112 is configured to support the multiple bands. The RAUs 112(1), 112(P), by their configuration to support the multiple communication paths from the main RIMs 122(1)-122(M) and second RIMs 122(M+1), 122(M+1+Z) in the MIMO configuration, are configured to support multiple band MIMO. The second RIMs 122(M+1), 122(M+1+Z) may be configured like the second RIM 122(M+1)′ in FIG. 7 and FIG. 9, except that frequency conversion components are not required. Similarly, the first and second RAUs 112(1), 112(P) may be configured similar to the RAU 112(1) and RXU 170, respectively, except that no expansion port need be provided in the first RAU 112(1), and frequency conversion components are not required in the second RAU 112(2).

Embodiments disclosed in the detailed description include optical fiber-based distributed antenna systems that provide and support both radio frequency (RF) communication services and digital data services. The RF communication services and digital data services can be distributed over optical fiber to client devices, such as remote antenna units for example. For example, non-limiting examples of digital data services include WLAN, WiMax, WiFi, Digital Subscriber Line (DSL), and LTE, etc. Digital data services can be distributed over optical fiber separate from optical fiber distributing RF communication services. Alternatively, digital data services can be distributed over common optical fiber with RF communication services. For example, digital data services can be distributed over common optical fiber with RF communication services at different wavelengths through wavelength-division multiplexing (WDM) and/or at different frequencies through frequency-division multiplexing (FDM). Power distributed in the optical fiber-based distributed antenna system to provide power to remote antenna units can also be accessed to provide power to digital data service components.

It may be desirable to provide both digital data services and RF communications services for client devices in the optical fiber-based distributed antenna systems discussed above. For example, it may be desirable to provide digital data services and RF communications services in a building infrastructure (e.g., the building infrastructure 70) (FIGS. 3A and 3B) to client devices located therein. Wired and wireless devices may be located in a building infrastructure that are configured to access digital data services. Examples of digital data services include, but are not limited to, Ethernet, WLAN, WiMax, WiFi, Digital Subscriber Line (DSL), and LTE, etc. Ethernet standards could be supported, including but not limited to 100 Megabits per second (Mbs) (i.e., fast Ethernet) or Gigabit (Gb) Ethernet, or ten Gigabit (10 G) Ethernet. Examples of digital data devices include, but are not limited to, wired and wireless servers, wireless access points (WAPs), gateways, desktop computers, hubs, switches, remote radio heads (RRHs), baseband units (BBUs), and femtocells. A separate digital data services network can be provided to provide digital data services to digital data devices.

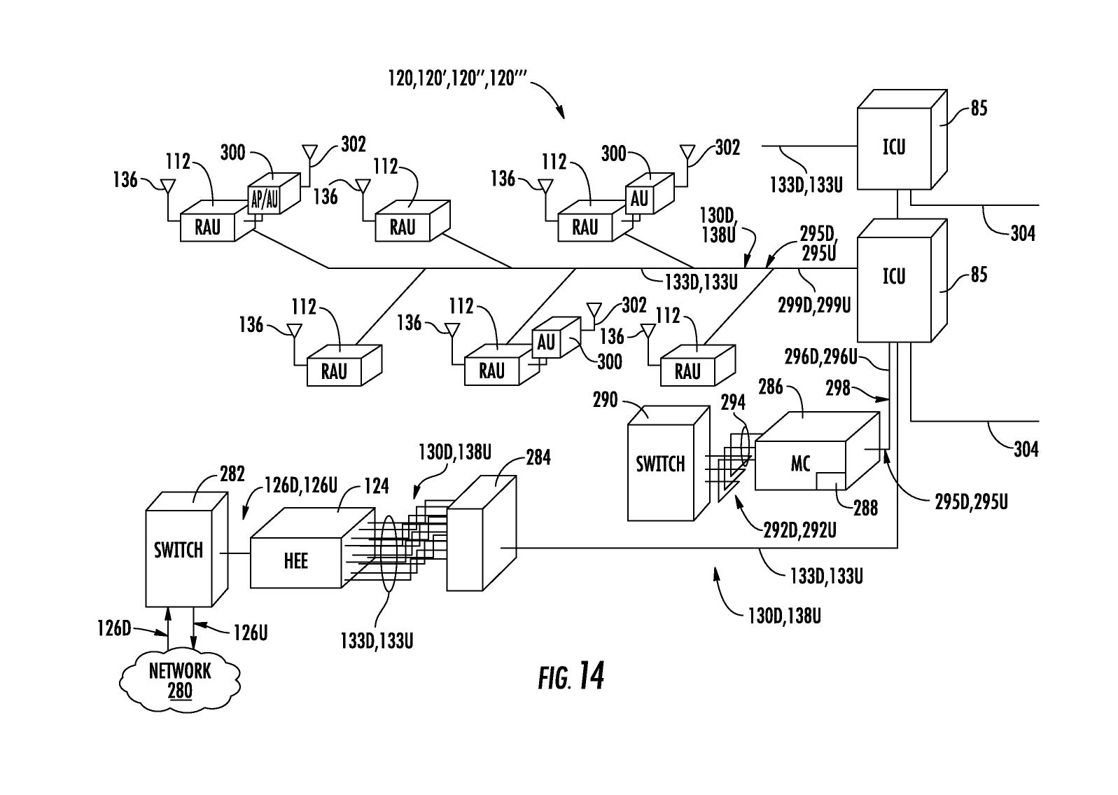

In this regard, FIG. 14 is a schematic diagram of an exemplary embodiment of providing digital data services over separate downlink and uplink optical fibers from RF communications services to RAUs in an optical fiber-based distributed antenna system 120. The optical fiber-based distributed antenna system illustrated in FIG. 14 could be any of the optical fiber-based distributed antenna systems 120, 120′, 120″, 120′″. However, note that the optical fiber-based distributed antenna system in FIG. 14 could also employ other components, including those in the optical fiber-based distributed antenna system 90 in FIG. 4.

As illustrated in FIG. 14, the HEE 124 is provided. The HEE 124 receives the downlink electrical RF communications signals 126D from the BTS 282. As previously discussed, the HEE 124 converts the downlink electrical RF communications signals 126D to downlink optical RF communications signals 295D to be distributed to the RAUs 112. The HEE 124 is also configured to convert the uplink optical RF communications signals 138U received from the RAUs 112 into uplink electrical RF communications signals 126U to be provided to the BTS 282 and onto a network 280 connected to the BTS 282. A patch panel 284 may be provided to receive the downlink and uplink optical fibers 133D, 133U configured to carry the downlink and uplink optical RF communications signals 130D, 138U. The downlink and uplink optical fibers 133D, 133U may be bundled together in one or more riser cables 84 and provided to one or more ICUs 85, as previously discussed.

To provide digital data services in the optical fiber-based distributed antenna system 120 in this embodiment, a digital data services controller (also referred to as “DDS controller”) 286 in the form of a media converter in this example is provided. The DDS controller 286 can include only a media converter for provision media conversion functionality or can include additional functionality to facilitate digital data services. The DDS controller 286 is configured to provide digital data services over a communications link, interface, or other communications channel or line, which may be either wired, wireless, or a combination of both. The DDS controller 286 may include a housing configured to house digital media converters (DMCs) 126 to interface to a DDS switch 290 to support and provide digital data services. For example, the DDS switch 290 could be an Ethernet switch. The DDS switch 290 may be configured to provide Gigabit (Gb) Ethernet digital data service as an example. The DMCs 126 are configured to convert electrical digital signals to optical digital signals, and vice versa. The DMCs 126 may be configured for plug and play installation (i.e., installation and operability without user configuration required) into the DDS controller 286. For example, the DMCs 126 may include Ethernet input connectors or adapters (e.g., RJ-45) and optical fiber output connectors or adapters (e.g., LC, SC, ST, MTP).

With continuing reference to FIG. 14, the DDS controller 286 (via the DMCs 126) in this embodiment is configured to convert downlink electrical digital signals (or downlink electrical digital data services signals) 292D over digital line cables 294 from the DDS switch 290 into downlink optical digital signals (or downlink optical digital data services signals) 295D that can be communicated over downlink optical fiber 133D to RAUs 112. The DDS controller 286 (via the DMCs 126) is also configured to receive uplink optical digital signals 295U from the RAUs 112 via the uplink optical fiber 133U and convert the uplink optical digital signals 295U into uplink electrical digital signals 292U to be communicated to the DDS switch 290. In this manner, the digital data services can be provided over optical fiber as part of the optical fiber-based distributed antenna system 120 to provide digital data services in addition to RF communication services. Client devices located at the RAUs 112 can access these digital data services and/or RF communications services depending on their configuration. Exemplary digital data services include Ethernet, WLAN, WiMax, WiFi, Digital Subscriber Line (DSL), and LTE, etc. Ethernet standards could be supported, including but not limited to 100 Megabits per second (Mbs) (i.e., fast Ethernet) or Gigabit (Gb) Ethernet, or ten Gigabit (10 G) Ethernet.

With continuing reference to FIG. 14, in this embodiment, downlink and uplink optical fibers 296D, 296U are provided in a fiber optic cable 298 that is interfaced to the ICU 85. The ICU 85 provides a common point in which the downlink and uplink optical fibers 296D, 296U carrying digital optical signals can be bundled with the downlink and uplink optical fibers 133U, 133D carrying optical RF communications signals. One or more of the fiber optic cables 298, also referenced herein as array cables 298, can be provided containing the downlink and uplink optical fibers 133D, 133U for RF communications services and digital data services to be routed and provided to the RAUs 112. Any combination of services or types of optical fibers can be provided in the array cable 298. For example, the array cable 298 may include single mode and/or multi-mode optical fibers for RF communication services and/or digital data services.

Examples of ICUs that may be provided in the optical fiber-based distributed antenna system 120 to distribute both downlink and uplink optical fibers 133D, 133U for RF communications services and digital data services are described in U.S. patent application Ser. No. 12/466,514, filed on May 15, 2009, entitled “Power Distribution Devices, Systems, and Methods For Radio-Over-Fiber (RoF) Distributed Communication,” and U.S. Provisional patent application Ser. No. 13/025,719, filed on Feb. 11, 2011, entitled “Digital Data Services and/or Power Distribution in Optical Fiber-based Distributed Communications Systems Providing Digital Data and Radio Frequency (RF) Communications Services, and Related Components and Methods,” both of which are incorporated herein by reference in their entireties.

With continuing reference to FIG. 14, some RAUs 112 can be connected to access units (AUs) 300, which may be access points (APs) or other devices supporting digital data services. AUs 300 can also be connected directly to the HEE 124. AUs 300 are illustrated, but the AUs 300 could be any other device supporting digital data services. In the example of AUs, the AUs 300 provide access to the digital data services provided by the DDS switch 290. This is because the downlink and uplink optical fibers 133D, 133U carrying downlink and uplink optical digital signals 295D, 295U converted from downlink and uplink electrical digital signals 292D, 292U from the DDS switch 290 are provided to the AUs 300 via the array cables 298 and RAUs 112. Digital data client devices can access the AUs 300 to access digital data services provided through the DDS switch 290. The AUs 300 may also each include an antenna 302 to provide wireless access to digital data services provided through the DDS switch 290.

As will be described in more detail below, providing RF communications services and digital data services involves providing RF communications modules and DDS modules in the RAUs 112 and/or AUs 300 in the example of FIG. 14. These modules are power-consuming modules that require power to operate. Power distributed to the RAUs can also be used to provide access to power for DDS modules, as opposed to providing separate power sources for DDS modules and RF communications modules. For example, power distributed to the RAUs 112 in FIG. 14 by or through the ICUs 85 can also be used to provide power to the AUs 138 located at the RAUs 112 in the optical fiber-based distributed antenna system 120. In this regard, the ICUs 85 may be configured to provide power for both RAUs 112 and the AUs 138 over an electrical power line 304, as illustrated in FIG. 14. As will also be described in more detail below, the RAUs 112 and/or AUs 138 may also be configured with powered ports to provide power to external client devices connected to the powered ports, such as IEEE 802.3af Power-over-Ethernet (PoE) compatible devices as an example. However, referring to FIG. 14 as an example, the power made available to the RAUs 112 and AUs 138 may not be sufficient to power all of the modules provided and external devices connected to the RAUs 112 and AUs 138.

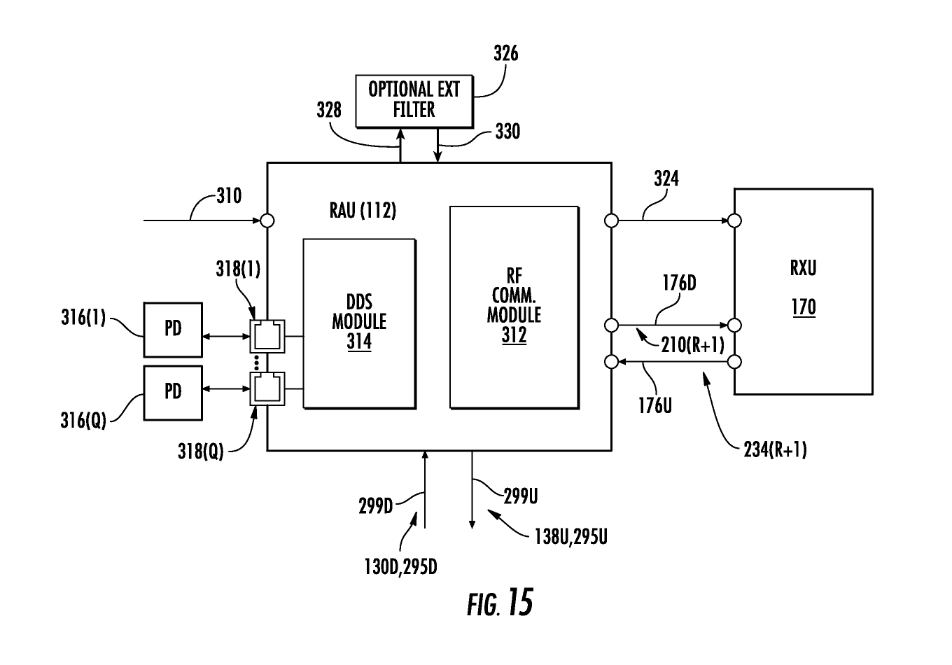

FIG. 15 is a schematic diagram of an exemplary RAU 112 configured with power-consuming components. The RAU 112 is configured to receive power over a power line 310 routed to the RAU 112 from either a local power source or a remote power source to make power available for power-consuming components associated with the RAU 112. As a non-limiting example, the power line 310 may provide a voltage of between forty-eight (48) and sixty (60) Volts at a power rating of between eighty (80) to one hundred (100) Watts. In this example, the RAU 112 includes an RF communications module 312 for providing RF communications services. The RF communications module 312 requires power to operate in this embodiment and receives power from the power line 310. Power from the power line 310 may be routed directly to the RF communications module 312, or indirectly through another module. The RF communications module 312 may include any of the previously referenced components to provide RF communications services, including 0/E and E/O conversion.

With continuing reference to FIG. 6, the RAU 112 may also include a DDS module 314 to provide media conversion (e.g., 0/E and E/O conversions) and route digital data services received from the DDS switch 127 in FIG. 14 to externally connected power-consuming devices (PDs) 316(1)-316(Q) configured to receive digital data services. As non-limiting examples, the DDS module 314 may be a fast Ethernet module (FEM) or Gigabit Ethernet (GE). For example, these two Ethernet options could be available per remote location: e.g., 100 MB Option (Fast Ethernet—FE); and 1 GB Option (Gigabit Ethernet—GE). The RAU 112 may also be configured for Power over Ethernet (PoE) to the device is provided by the FEM and complies with IEEE 802.3af as one option standard.

Power from the power line 310 may be routed to the RF communications module 312, and from the RF communications module 312 to the DDS module 314. With reference to FIG. 6, the digital data services are routed by the DDS module 314 through powered communications ports 318(1)-318(Q) provided in the RAU 112. As a non-limiting example, the powered communications ports 318(1)-318(Q) may be RJ-45 connectors. The powered communications ports 318(1)-318(Q) may be powered, meaning that a portion of the power from the power line 310 is provided to the powered communications ports 318(1)-318(Q). In this manner, PDs 316(1)-316(Q) configured to receive power through a powered communications port 318 can be powered from power provided to the RAU 112 when connected to the powered communications port 318. In this manner, a separate power source is not required to power the PDs 316(1)-316(Q). For example, the DDS module 314 may be configured to route power to the powered communications ports 318(1)-318(Q) as described in the PoE standard.

With continuing reference to FIG. 6, one or more remote expansion units (RXUs) 170(1)-170(Z) may also be connected to the RAU 112. The RXUs 170(1)-170(Z) can be provided to provide additional RF communications services through the RAU 112, but remotely from the RAU 112. For example, if additional RF communications bands are needed and there are no additional bands available in a distributed antenna system, the RF communications bands of an existing RAU 112 can be expanded without additional communications bands by providing the RXUs 170(1)-170(Z). The RXUs 170(1)-170(Z) are connected to the distributed antenna system through the RAU 112. The RXUs 170(1)-170(Z) can include the same or similar components provided in the RF communications module 312 to receive downlink optical fiber 176D and to provide received uplink optical fiber 176U from client devices to the distributed antenna system through the RAU 112. An optional external filter 326 may be coupled via input link 328 to receive the downlink RF communications signals received from the downlink optical fiber 176D, provide additional filtering, and return the filtered signals back via an output link 330. The RXUs 170(1)-170(Z) are also power-consuming modules, and thus in this embodiment, power from the power line 310 is routed by the RAU 112 to the RXUs 170(1)-170(Z) over a power line 324.

The power provided on the power line 310 in FIG. 15 may not be sufficient to provide power for the modules 312, 314, and RXUs 170(1)-170(Z) and external PDs 316(1)-316(Q) provided in the RAU 112. For example, eighty (80) Watts of power may be provided on the power line 310 in FIG. 15. However, the RF communications module 312 may consume thirty (30) Watts of power, the RXUs 170(1)-170(Z) may consume twenty (20) Watts of power, and the DDS module 314 may consume five (5) Watts of power. This is a total of fifty-five (55) Watts. In this example, twenty-five (25) Watts are available to be shared among the powered communications ports 318(1)-318(Q). However, the PDs 316(1)-316(Q) may be configured to require more power than twenty-five (25) Watts. For example, if the PDs 316(1)-316(Q) are configured according to the PoE standard, power source equipment (PSE) provided in the RAU 112 to provide power to the powered communications ports 318(1)-318(Q) may be required to provide up to 15.4 Watts of power to each powered communications port 318(1)-318(Q). In this example, if more than one powered communications port 318(1)-318(Q) is provided, there will not be sufficient power to power each of the powered communications port 318(1)-318(Q) at 30 Watts (i.e., a PoE Class 4 device).

Thus, to ensure proper operation of the maximum power consuming modules 312, 314, 170(1)-170(Z) possible in an RAU 112, less power could be provided to the powered communications ports 318(1)-318(Q) or only one powered communications port 318(1)-318(Q) could be enabled with power. However, if one of the other modules 312, 314, 170(1)-170(Z) was not present, sufficient power may be available to be provided to each of the powered communications ports 318(1)-318(Q) provided. Further, if a PD 316 connected to a powered communication port 318 is a lower class device that does not require 30 Watts of power, there may be sufficient power available to power the PDs 316(1)-316(Q) connected to each of the powered communications ports 318(1)-318(Q).

The HEE 124 is also configured to provide the external interface services a network. In the exemplary systems, the management system for the distributed antenna systems: include a user friendly Web-based interface that allows intuitive Configuration, Monitoring, and Management tools; provides end-to-end system control and management capabilities for all main system parameters via SNMP (antenna connectivity, input and output RF Power per band, Overload Protection, and AGC status); and Allows easy deployment and commissioning (Auto Adjustment, Calibration, and Report generation, and Supports Remote SW Upgrade to address future functionality.

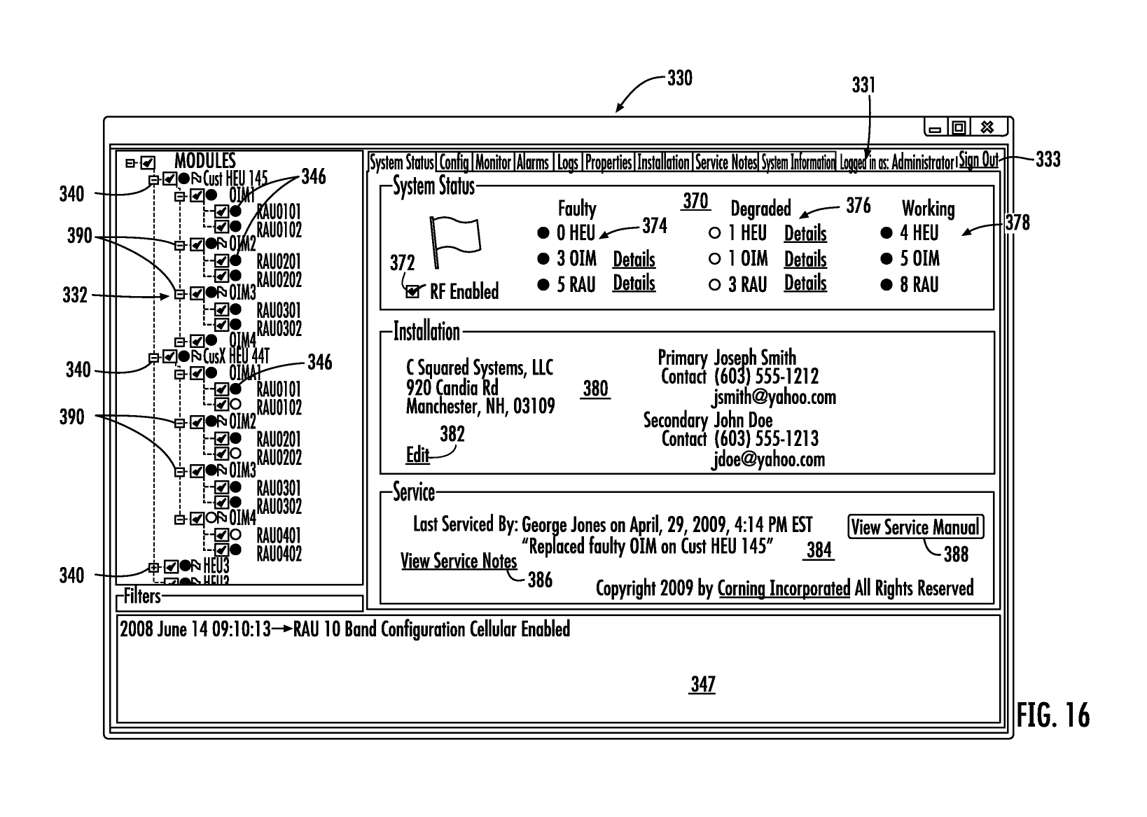

In this regard, FIG. 16 illustrates the default page 330 when the “System Notes” tab 332 has been selected by a client. The default page 330 is also displayed as the initial page after a user has logged in. As illustrated, the overall or “snapshot” of the system status is provided in a “System Status” area 370. If RF communication has been enabled, an “RF Enabled” check box 372 is selected. RF communications can be disabled by unselecting the “RF Enabled” check box 372 if such permission is granted to the user, otherwise the “RF Enabled” check box 372 will be unselectable. The number of faulty HEEs 124, OIMs 128, and RAUs 112 are listed in a “Faulty” section 374, meaning these components are at fault. The number of degraded components is also listed in a “Degraded” section 376, meaning a fault condition exists, but the components may be operational. The number of operational components without faults are listed in a “Working” section 378. The details regarding the installer and primary and secondary contacts can be displayed in an installation area 380. This information can be edited by selecting the “Edit” link 382. Notes regarding the last service are displayed in a “Service” area 384. Service notes entered by a service technician can be displayed by selecting the “View Service Notes” link 386. The service manual can be viewed by selecting the “View Service Manual” link 388. If more information regarding identifying which HEEs 124, OIMs 128, and RAUs 112 in particular are at fault, the expansion buttons 340 can be selected to expand and display the OIMs 128 for each expanded HEE 124 in the banner 332. Expansion buttons 390 for each OIM 128 can be further selected to display the RAUs 112 for each expanded OIM 128. Status icons 346 and status flags 348 are displayed beside the modules that contain warning or errors. Status flags 348 are not displayed beside the RAUs 112, because the RAUs 112 have no further sub-components that are tracked for errors at the system level accessible externally through the HEE 124.

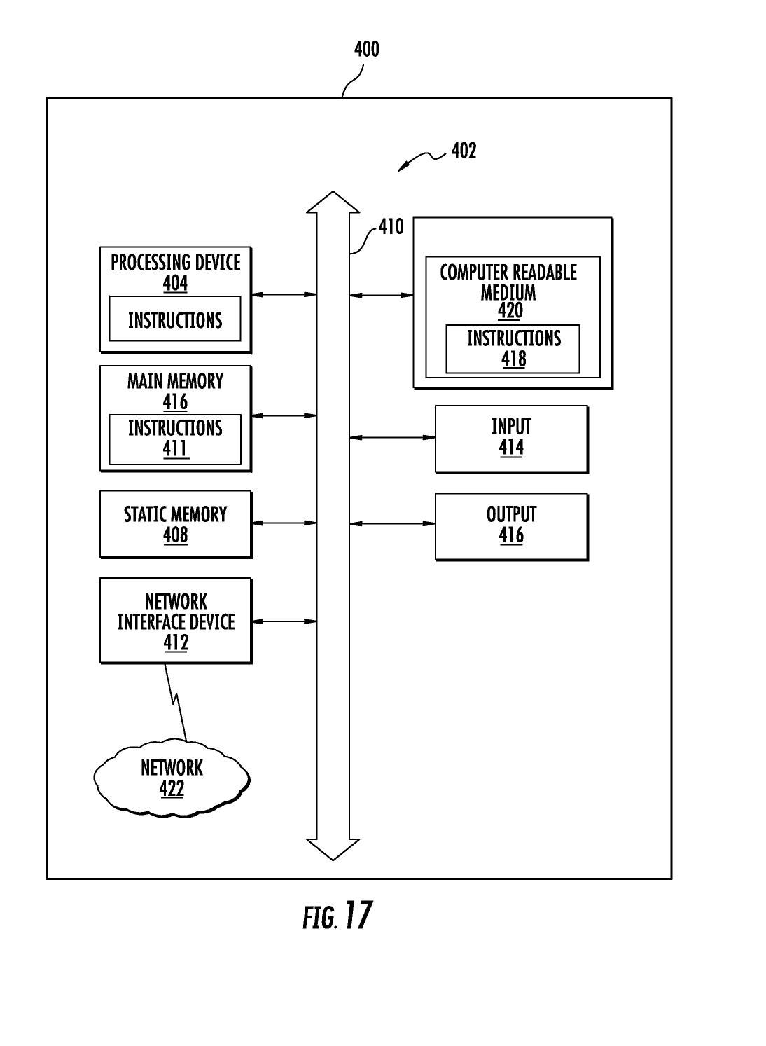

FIG. 17 is a schematic diagram representation of additional detail regarding the exemplary HEC 91 or 157 in the exemplary form of an exemplary computer system 400 adapted to execute instructions from an exemplary computer-readable medium to perform power management functions. The HEC 91, 157 may also be included in the HEE 124. In this regard, the HEC 91, 157 may comprise the computer system 400 within which a set of instructions for causing the HEC 91, 157 to perform any one or more of the methodologies discussed herein may be executed. The HEC 91, 157 may be connected (e.g., networked) to other machines in a LAN, an intranet, an extranet, or the Internet. The HEC 91, 157 may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The HEC 91, 157 may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server or a user's computer.

The exemplary computer system 400 of the HEC 91, 157 in this embodiment includes a processing device or processor 402, a main memory 404 (e.g., read-only memory (ROM), flash memory, dynamic random access memory (DRAM) such as synchronous DRAM (SDRAM), etc.), and a static memory 406 (e.g., flash memory, static random access memory (SRAM), etc.), which may communicate with each other via the data bus 236. Alternatively, the processing device 402 may be connected to the main memory 404 and/or static memory 406 directly or via some other connectivity means. The processing device 402 may be a controller, and the main memory 404 or static memory 406 may be any type of memory, each of which can be included in the HEE 124.

The processing device 402 represents one or more general-purpose processing devices such as a microprocessor, central processing unit, or the like. More particularly, the processing device 402 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 402 is configured to execute processing logic in instructions 408 for performing the operations and steps discussed herein.

The computer system 400 may further include a network interface device 410. The computer system 400 also may or may not include an input 412 to receive input and selections to be communicated to the computer system 400 when executing instructions. The computer system 400 also may or may not include an output 414, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 400 may or may not include a data storage device that includes instructions 416 stored in a computer-readable medium 418. The instructions 416 may also reside, completely or at least partially, within the main memory 404 and/or within the processing device 402 during execution thereof by the computer system 400, the main memory 404 and the processing device 402 also constituting computer-readable medium. The instructions 416 may further be transmitted or received over a network 260 via the network interface device 410.

While the computer-readable medium 418 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical and magnetic medium, and carrier wave signals.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.), a machine-readable transmission medium (electrical, optical, acoustical or other form of propagated signals (e.g., carrier waves, infrared signals, digital signals, etc.)), etc.

Unless specifically stated otherwise as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163, the disclosures of which are incorporated herein by reference in their entireties.

Many modifications and other embodiments of the embodiments set forth herein will come to mind to one skilled in the art to which the embodiments pertain having the benefit of the teachings presented in the foregoing descriptions and the associated drawings. For example, the distributed antenna systems could include any type or number of communications mediums, including but not limited to electrical conductors, optical fiber, and air (i.e., wireless transmission). The distributed antenna systems may distribute any type of communications signals, including but not limited to RF communications signals and digital data communications signals, examples of which are described in U.S. patent application Ser. No. 12/892,424 entitled “Providing Digital Data Services in Optical Fiber-based Distributed Radio Frequency (RF) Communications Systems, And Related Components and Methods,” incorporated herein by reference in its entirety. Multiplexing, such as WDM and/or FDM, may be employed in any of the distributed antenna systems described herein, such as according to the examples provided in U.S. patent application Ser. No. 12/892,424.

Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

We claim:

1. An apparatus configured to distribute radio-frequency (RF) communications signals in a distributed antenna system in a multiple-input, multiple-output (MIMO) configuration, comprising:
at least one first radio interface configured to distribute received first downlink electrical RF communications signals in a first radio band frequency into first downlink electrical RF communications signals;
at least one second radio interface configured to distribute received second downlink electrical RF communications signals in the first radio band frequency into second downlink electrical RF communications signals;
at least one first optical interface configured to:
receive the first downlink electrical RF communications signals from the at least one first radio interface;
convert the received first downlink electrical RF communications signals from the at least one first radio interface into first downlink optical RF communications signals;
distribute the first downlink optical RF communications signals over optical fiber in a first downlink communication path to at least one remote antenna unit (RAU); and
at least one second optical interface configured to:
receive the second downlink electrical RF communications signals from the at least one second radio interface;
convert the received second downlink electrical RF communications signals from the at least one second radio interface into second downlink optical RF communications signals; and
distribute the second downlink optical RF communications signals over optical fiber in a second downlink communication path to at least one second remote unit.

2. The apparatus of claim 1, wherein the first downlink communication path and the second downlink communication path are provided by a common optical fiber.

3. The apparatus of claim 1, wherein the at least one first optical interface and the at least one second optical interface are provided by a common optical interface.

4. The apparatus of claim 1, wherein the at least one second remote interface is further comprised of at least one frequency converter configured to convert the frequency of the second downlink electrical RF communications signals to a different frequency from the first radio band.

5. The apparatus of claim 4, wherein the at least one RAU is configured to receive the first downlink optical RF communications signals and receive the second downlink optical RF communications signals.

6. The apparatus of claim 5, wherein the at least one RAU is further configured to convert the received first downlink optical RF communications signals into first converted downlink electrical RF communications signals, and convert the received second downlink optical RF communications signals into second converted downlink electrical RF communications signals.

7. The apparatus of claim 6, wherein the at least one second remote unit is configured to receive the second converted downlink electrical RF communications signals from the at least one RAU.

8. The apparatus of claim 7, wherein the second remote unit is further comprised of at least one second frequency converter configured to convert the frequency of the second converted downlink electrical RF communications signals into the frequency of the first radio band.

9. The apparatus of claim 6, wherein the at least one RAU is further configured to transmit the first converted downlink electrical RF communications signals at the frequency of the first radio band.

10. The apparatus of claim 1, wherein the at least one second remote unit is comprised of at least one remote expansion unit communicative coupled to the at least one RAU.

11. The apparatus of claim 1, wherein the at least one second unit is comprised of a second unit configured to provide a single band MIMO configuration.

12. The apparatus of claim 1, wherein the at least one RAU is comprised of at least one first RAU configured to received the first downlink optical RF communications signals and at least one second remote unit configured receive the second downlink optical RF communications signals.

13. The apparatus of claim 12, wherein the at least one first RAU is further configured to convert the received first downlink optical RF communications signals into first converted downlink electrical RF communications signals, and the at least one second RAU is further configured to convert the received second downlink optical RF communications signals into second converted downlink electrical RF communications signals.

14. The apparatus of claim 12, wherein the at least one first RAU is further configured to transmit the first converted downlink electrical RF communications signals at the frequency of the first radio band, and the at least one second RAU is further configured to transmit the second converted downlink electrical RF communications signals at the frequency of the first radio band.

15. The apparatus of claim 1, wherein the at least one first radio interface is comprised of a plurality of first radio interfaces each configured to communication at different radio bands comprising a first MIMO radio interface set, and the at least one second radio interface is comprised of a plurality of second radio interfaces configured to communication at the different radio bands of the plurality of first radio interfaces and comprising a second MIMO radio interface.

16. The apparatus of claim 1, wherein
the at least one first optical interface is further configured to:
receive first uplink optical RF communications signal at a frequency in the first radio band from the at least one RAU over a first uplink communications path;
convert the received first uplink optical RF communications signals into first received uplink electrical RF communications signals; and
distribute the first uplink electrical RF communications signals to at least one first radio interface; and
the at least one second optical interface is further configured to:
receive second uplink optical RF communications signal from the at least one second remote unit over a second uplink communications path;
convert the received second uplink optical RF communications signals into second received uplink electrical RF communications signals; and
distribute the second uplink electrical RF communications signals to at least one second radio interface.

17. A method of distributing radio-frequency (RF) communications signals in a distributed antenna system in a multiple-input, multiple-output (MIMO) configuration, comprising:
distributing received first downlink electrical RF communications signals in a first radio band frequency into first downlink electrical RF communications signals from at least one first radio interface;
distributing received second downlink electrical RF communications signals in the first radio band frequency into second downlink electrical RF communications signals from at least one second radio interface;
in at least one first optical interface:
receiving the first downlink electrical RF communications signals from the at least one first radio interface;
converting the received first downlink electrical RF communications signals from the at least one first radio interface into first downlink optical RF communications signals;
distributing the first downlink optical RF communications signals over optical fiber in a first downlink communication path to at least one remote antenna unit (RAU); and
in at least one second optical interface:
receiving the second downlink electrical RF communications signals from the at least one second radio interface;
converting the received second downlink electrical RF communications signals from the at least one second radio interface into second downlink optical RF communications signals; and
distributing the second downlink optical RF communications signals over optical fiber in a second downlink communication path to at least one second remote unit.

18. The method of claim 17, wherein the first downlink communication path and the second downlink communication path are provided by a common optical fiber.

19. The method of claim 17, further comprising converting the frequency of the second downlink electrical RF communications signals to a different frequency from the first radio band in the at least one second remote interface.

20. The method of claim 17, further comprising receiving the first downlink optical RF communications signals and receiving the second downlink optical RF communications signals in the at least one RAU.

21. The method of claim 20, further comprising converting the received first downlink optical RF communications signals into first converted downlink electrical RF communications signals in the at least one RAU, and converting the received second downlink optical RF communications signals into second converted downlink electrical RF communications signals in the at least one RAU.

22. The method of claim 21, further comprising receiving the second converted downlink electrical RF communications signals in the at least one second remote unit from the at least one RAU.

23. The method of claim 17, wherein the at least one second remote unit is comprised of at least one remote expansion unit communicative coupled to the at least one RAU.

24. The method of claim 23, wherein the at least one RAU is further comprised of at least one expansion port configured to be communicative coupled to the at least one remote expansion unit.

25. The method of claim 23, wherein the at least one RAU is co-located with the at least one remote expansion unit.

26. The method of claim 17, further comprising receiving the first downlink optical RF communications signals in the at least one RAU, and receiving the second downlink optical RF communications signals in the at least one second remote unit.

27. The method of claim 26, further comprising converting the received first downlink optical RF communications signals into first converted downlink electrical RF communications signals in the at least one first RAU, and further comprising converting the received second downlink optical RF communications signals into second converted downlink electrical RF communications signals in the at least one second RAU.

28. The method of claim 17, wherein the at least one first radio interface is comprised of a plurality of first radio interfaces communicating at different radio bands comprising a first MIMO radio interface set, and the at least one second radio interface is comprised of a plurality of second radio interfaces communicating at the different radio bands of the plurality of first radio interfaces and comprising a second MIMO radio interface.

29. The method of claim 17, wherein
in the at least one first optical interface:
receiving first uplink optical RF communications signal at a frequency in the first radio band from the at least one RAU over a first uplink communications path;
converting the received first uplink optical RF communications signals into first received uplink electrical RF communications signals; and
distributing the first uplink electrical RF communications signals to at least one first radio interface; and
in the at least one second optical interface:
receiving second uplink optical RF communications signal from the at least one second remote unit over a second uplink communications path;
converting the received second uplink optical RF communications signals into second received uplink electrical RF communications signals; and
distributing the second uplink electrical RF communications signals to at least one second radio interface.
